(19) United States
(12) Patent Application Publication
(10) Pub. No.: US 2024/0199804 A1
(43) Pub. Date: Jun. 20, 2024

(54) METHOD FOR PRODUCING THERMOPLASTIC RESIN, AND COMPOUND THEREFOR

(71) Applicants: Mitsubishi Chemical Corporation, Tokyo (JP); Agency For Science, Technology & Research, Singapore (SG)

(72) Inventors: Shohei Tomita, Tokyo (JP); Toshiki Monden, Tokyo (JP); Mitsunobu Ito, Tokyo (JP); Cun Wang, Singapore (SG); Martin Van Meurs, Singapore (SG); Boon Ying Tay, Singapore (SG)

(73) Assignees: Mitsubishi Chemical Corporation, Tokyo (JP); Agency For Science, Technology & Research, Singapore (SG)

(21) Appl. No.: 18/552,088

(22) PCT Filed: Mar. 15, 2022
(86) PCT No.: PCT/JP2022/011631

§ 371 Date: Sep. 22, 2023

(30) Foreign Application Priority Data
Mar. 23, 2021 (JP) 2021-048264

(51) Int. Cl. C08G 64/30

(52) U.S. Cl. CPC C08G 64/307

(57) ABSTRACT

Provided is a method for producing at least one type of thermoplastic resin selected from polycarbonate, polyester and polyester carbonate. The method includes a step of subjecting a dihydroxy compound and diaryl carbonate and/or dicarboxylic acid ester to melt polycondensation in the presence of a transesterification catalyst selected from a compound represented by formula (1) and/or formula (2). In formula (1), R¹ to R²⁴ are each a hydrogen atom, an alkyl group having 1-10 carbon atoms or a cycloalkyl group. Some of the carbon atoms may be substituted by heteroatoms. Among R¹ to R²⁴, alkyl groups or the like substituted on the same N atom may bond to each other to form a ring. The values of a to d are each 0 or 1. X⁻ is a monovalent anion. In formula (2), Ar¹ to Ar¹² are each a substituted or unsubstituted aryl group. M⁻ is a monovalent anion.

The present invention relates to a method for producing at least one thermoplastic resin selected from the group consisting of a polycarbonate, a polyester, and a polyester carbonate. More specifically, it relates to a method for producing at least one thermoplastic resin selected from the group consisting of a polycarbonate, a polyester, and a polyester carbonate using a transesterification catalyst having excellent reactivity even when added in small amounts, with a low amount of specified by-products. The present invention further relates to a compound useful as a transesterification catalyst for the production of at least one thermoplastic resin selected from the group consisting of a polycarbonate, a polyester, and a polyester carbonate.

### BACKGROUND OF THE INVENTION

Several methods are known for the production of at least one thermoplastic resin selected from the group consisting of a polycarbonate, a polyester, and a polyester carbonate. Among them, a dihydroxy compound (e.g., bisphenol A) is reacted with an ester-forming compound (e.g., diaryl carbonate or dicarboxylic acid ester) in the presence of a transesterification catalyst by melt transesterification to produce at least one thermoplastic resin selected from the group consisting of a polycarbonate, a polyester, and a polyester carbonate. This method is preferred as a commercial process because it has several advantages: no environmentally harmful solvents are used; the energy required for production is low; and impurities such as chlorine contamination in the product are low.

As the aforementioned transesterification catalyst, conventional metal catalysts such as alkali metals, alkaline earth metals and transition metals are known.

Methods using quaternary onium salts such as phosphonium salts and ammonium salts (see Patent document 1), methods using organic base catalysts such as nitrogen-containing basic compounds (e.g., Patent documents 2˜4), and methods combining the aforementioned metal catalysts and organic base catalysts (e.g., Patent documents 5˜7) have also been proposed.

A method using a catalyst having an imidazole structure is disclosed in Patent documents 8 and 9.

A method using a catalyst having a phosphazene structure is disclosed in Patent document 10.

Patent document 1: JP-A-2004-526839

Patent document 2: JP-A-7-82363

Patent document 3: JP-A-2016-183287

Patent document 4: JP-A-2-124934

Patent document 5: JP-A-5-1145

Patent document 6: JP-A-7-109346

Patent document 7: JP-A-2014-101487

Patent document 8: Chinese Patent Application Publication No. 107573497

Patent document 9: JP-A-2020-132767

Patent document 10: JP-A-7-330886

In the method for producing at least one thermoplastic resin selected from the group consisting of a polycarbonate, a polyester, and a polyester carbonate by transesterification, a dihydroxy compound and an ester-forming “compound are melted, and a transesterification catalyst is added under high vacuum conditions. Polycondensation is carried out while the monohydroxy compound (phenol, etc.) is distilled off. In this method, the high-temperature conditions cause side reactions, resulting in the formation of colored components or certain by-products that adversely affect weather resistance and flowability.

When a metal catalyst is used as the transesterification catalyst, the color tone of at least one thermoplastic resin selected from the group consisting of a polycarbonate, a polyester, and a polyester carbonate is easily degraded, and by-products are easily formed. In addition, the obtained at least one thermoplastic resin selected from the group consisting of a polycarbonate, a polyester, and a polyester carbonate has the disadvantage of poor thermal stability, especially poor color stability during melt retention and poor resistance to hydrolysis at high temperatures.

At least one thermoplastic resin selected from the group consisting of a polycarbonate, a polyester, and a polyester carbonate produced with an organic catalyst tended to have fewer by-products than at least one thermoplastic resin selected from the group consisting of a polycarbonate, a polyester, and a polyester carbonate obtained with a metal catalyst, but the level was still not satisfactory.

Organic catalysts have poor thermal stability compared to metal catalysts, resulting in a longer time for the at least one thermoplastic resin selected from the group consisting of a polycarbonate, a polyester, and a polyester carbonate to reach the desired molecular weight, i.e., lower reactivity.

Organic catalysts tend to cause at least one thermoplastic resin selected from the group consisting of a polycarbonate, a polyester, and a polyester carbonate to suffer from heat aging and poor color tone due to low reactivity and long polymerization time.

Polymerization with excessive amounts of organic catalysts improves the polymerization time, but does not suppress the formation of by-products, and also causes deterioration in the color tone of at least one thermoplastic resin selected from the group consisting of a polycarbonate, a polyester, and a polyester carbonate.

The technique of combining a metal catalyst with an organic catalyst also results in an increase in by-products in proportion to the amount of metal catalyst blended, as well as a deterioration in color tone. Therefore, it is still not possible to achieve a balance between polymerization activity and quality.

### SUMMARY OF THE INVENTION

It is therefore an object of the present invention to provide a method for producing at least one thermoplastic resin selected from the group consisting of a polycarbonate, a polyester, and a polyester carbonate by using an organic catalyst having a specific structure, which takes a short time to reach a desired molecular weight and has a low amount of a certain by-products, and a compound used as an organic catalyst having this specific structure.

The inventor, after investigating the relationship between reactivity, side reaction control in the production of at least one thermoplastic resin selected from the group consisting of a polycarbonate, a polyester, and a polyester carbonate, and the thermal stability and molecular structure of transesterification catalysts, found that by using compounds represented by formula (1) and/or formula (2) below, products that show excellent reactivity can be obtained with only a low amount of by-products even when a small amount is added.

The present invention may be summarized as follows.

[1] A method for producing at least one thermoplastic resin selected from the group consisting of a polycarbonate, a polyester, and a polyester carbonate, including the process of melt polycondensation of a dihydroxy compound with a diaryl carbonate and/or a dicarboxylic acid ester in the presence of a transesterification catalyst selected from a compound represented by formula (1) below and/or a compound represented by formula (2) below.

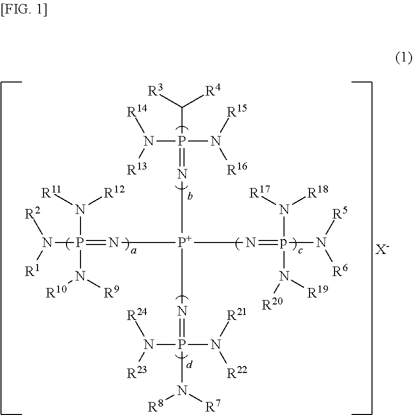

(In formula (1), R¹˜R²⁴ are each independently a hydrogen atom, an alkyl group having 1˜10 carbon atoms, or a cycloalkyl group, wherein some carbon atoms of the alkyl group or the cycloalkyl group may be replaced by heteroatoms, and among R¹˜R²⁴, alkyl groups substituted on the same N atom may be joined together to form a ring. R² and R³, R⁴ and R⁵, R⁶ and R⁷, R⁸ and R¹ may respectively be joined together to form a ring; R⁹ or R¹⁰, R¹ or R², and R¹¹ or R¹² may respectively be joined together to form a ring; R¹³ or R¹⁴, R³ or R⁴, and R¹⁵ or R¹⁶ may respectively be joined together to form a ring; R¹⁷ or R¹⁸ R⁵ or R⁶, and R¹⁹ or R²⁰ may respectively be joined together to form a ring; R²¹ or R^{22,} R⁷ or R⁸, and R²³ or R²⁴ may respectively be joined together to form a ring; R¹ or R², R³ or R⁴, and R⁵ or R⁶ may respectively be joined together to form a ring; R³ or R⁴, R⁵ or R⁶, and R⁸ or R⁷ may respectively be joined together to form a ring; R⁵ or R⁶, R⁸ or R⁷, and R¹ or R² may respectively be joined together to form a ring; and R⁷ or R⁸, R¹ or R², and R³ or R⁴ may respectively be joined together to form a ring. a˜d are independently 0 or 1. X⁻ is a monovalent anion.)

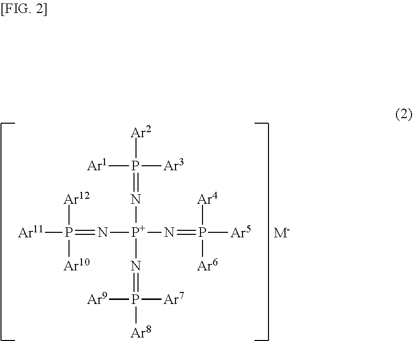

(In formula (2), Ar¹˜Ar¹² are each independently a substituted or unsubstituted aryl group; M⁻ is a monovalent anion.)

[2] The method for producing at least one thermoplastic resin selected from the group consisting of a polycarbonate, a polyester, and a polyester carbonate according to [1], wherein said dihydroxy compound is a bisphenol A.

[3] The method for producing at least one thermoplastic resin selected from the group consisting of a polycarbonate, a polyester, and a polyester carbonate according to [1] or [2], wherein said diaryl carbonate is a diphenyl carbonate.

[4] The method for producing at least one thermoplastic resin selected from the group consisting of a polycarbonate, a polyester, and a polyester carbonate according to any of [1]˜[3], wherein said dicarboxylic acid ester is a diphenyl terephthalate and/or a diphenyl isophthalate.

[5] The method for producing at least one thermoplastic resin selected from the group consisting of a polycarbonate, a polyester, and a polyester carbonate according to any of [1]˜[4], comprising a step of melt polycondensation of an aromatic dihydroxy compound and a diaryl carbonate in the presence of said transesterification catalyst.

[6] The method for producing at least one thermoplastic resin selected from the group consisting of a polycarbonate, a polyester, and a polyester carbonate according to any of [1]˜[5], wherein said transesterification catalyst is a compound represented by the said formula (1).

[7] The method for producing at least one thermoplastic resin selected from the group consisting of a polycarbonate, a polyester, and a polyester carbonate according to [6], wherein said formula (1) is represented by the following formula (1B).

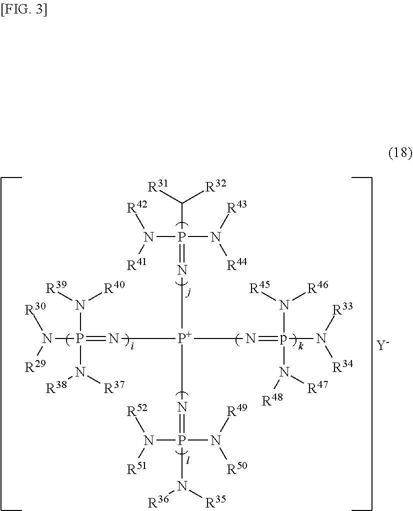

(In formula (1B), R²⁹˜R⁵² are each independently a hydrogen atom or an alkyl group having 1˜10 carbon atoms; among R²⁹˜ R⁵², alkyl groups substituted on the same N atom may be joined together to form a ring; R³⁰ and R³¹, R³² and R³³, R³⁴ and R³⁵, R³⁶ and R²⁹ may respectively be joined together to form a ring. i˜l are independently 0 or 1, respectively; Y⁻ is a monovalent anion.)

[8] The method for producing at least one thermoplastic resin selected from the group consisting of a polycarbonate, a polyester, and a polyester carbonate according to [6] or [7], wherein, in said formula (1), X⁻ is at least one kind selected from a chloride ion, a bromide ion, a tetraphenylborate ion, a phenolate ion, a BPA monoanion represented by formula (3a) below, and a BPA monoanion BPA adduct represented by formula (3b) below.

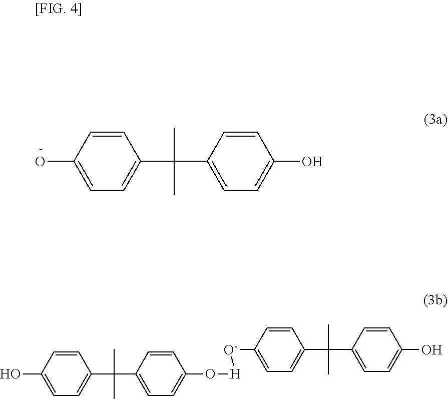

[9] The method for producing at least one thermoplastic resin selected from the group consisting of a polycarbonate, a polyester and a polyester carbonate according to [8], wherein, in said formula (1), X⁻ is at least one kind selected from a phenolate ion, a BPA monoanion represented by said formula (3a), and a BPA monoanion BPA adduct represented by said formula (3b).

[10] The method for producing at least one thermoplastic resin selected from the group consisting of a polycarbonate, a polyester, and a polyester carbonate according to any of [6]˜[9], wherein said formula (1) is represented by any of following formulas (1a)˜(1e).

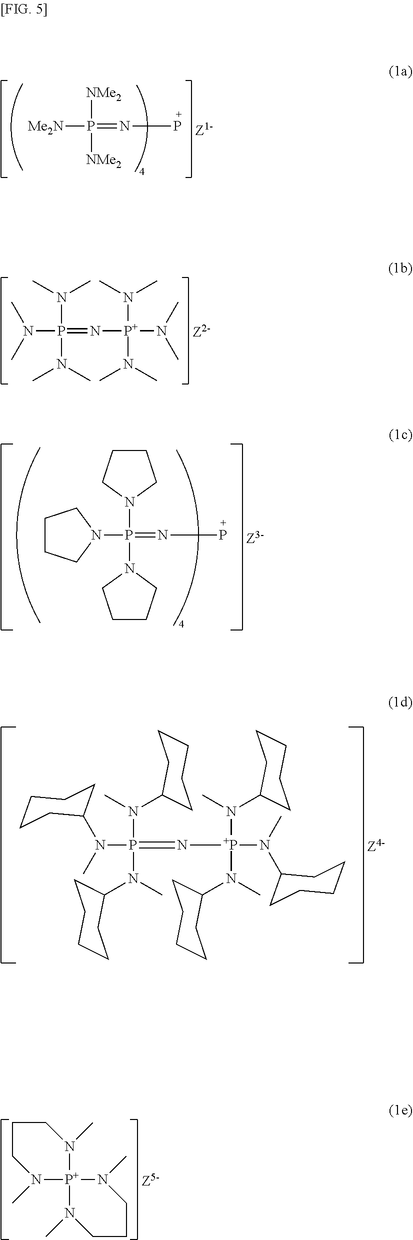

(In formulas (1a)˜(1e), Z¹⁻˜Z⁵⁻ each independently represent a monovalent anion; Me represents a methyl group.)

[11] The method for producing at least one thermoplastic resin selected from the group consisting of a polycarbonate, a polyester, and a polyester carbonate according to any of [1]˜[5], wherein said transesterification catalyst is a compound represented by said formula (2).

[12] The method for producing at least one thermoplastic resin selected from the group consisting of a polycarbonate, a polyester, and

a polyester carbonate according to [11], wherein, in said formula (2), Ar¹˜Ar¹² are phenyl groups.

[—] The method for producing at least one thermoplastic resin selected from the group consisting of a polycarbonate, a polyester, and a polyester carbonate according to [11] or [12], wherein, in said formula (2), M⁻ is at least one kind selected from a chloride ion, a bromide ion, a tetraphenylborate ion, a phenolate ion, a BPA monoanion represented by formula (3a) below, and a BPA monoanion BPA adduct represented by formulas (3b), (3c) below.

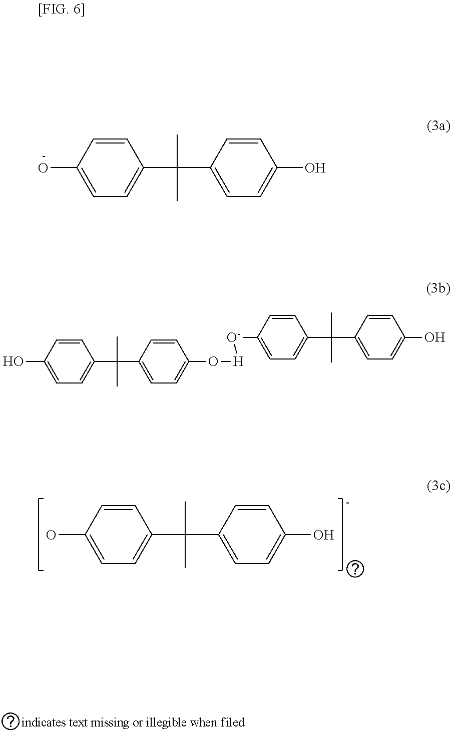

[14] The method for producing at least one thermoplastic resin selected from the group consisting of a polycarbonate, a polyester, and a polyester carbonate according to [13], wherein, in said formula (2), M⁻ is at least one kind selected from a phenolate ion, a BPA monoanion represented by said formula (3a), and a BPA monoanion BPA adduct represented by said formulas (3b), (3c).

[15] The method for producing at least one thermoplastic resin selected from the group consisting of a polycarbonate, a polyester, and a polyester carbonate according to any of [1]˜[14], wherein said melt polycondensation is performed in the presence of 0.01˜1000 μmol of said transesterification catalyst per 1 mol of said dihydroxy compound.

[16] The method for producing at least one thermoplastic resin selected from the group consisting of a polycarbonate, a polyester, and a polyester carbonate according to any of [1]˜[15], wherein the temperature during said melt polycondensation reaction is 200˜350° C.

[17] The method for producing at least one thermoplastic resin selected from the group consisting of a polycarbonate, a polyester, and

a polyester carbonate according to any of [1]˜[16], wherein the viscosity average molecular weight [Mv] of said at least one thermoplastic resin selected from the group consisting of a polycarbonate, a polyester, and a polyester carbonate produced is 5,000˜40,000.

[18] A transesterification catalyst for producing at least one thermoplastic resin selected from the group consisting of a polycarbonate, a polyester, and a polyester carbonate by melt polycondensation of a dihydroxy compound with a diaryl carbonate and/or a dicarboxylic acid ester, said catalyst being selected from any one of a group of compounds represented by formula (1) below and formula (2) below.

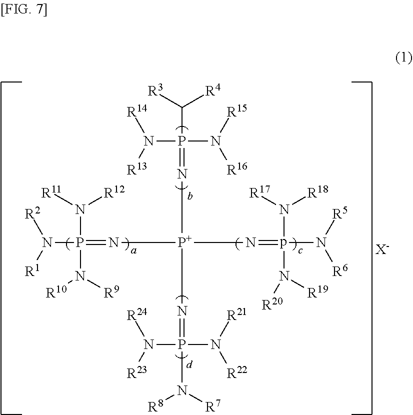

(In formula (1), R¹˜R²⁴ are each independently a hydrogen atom, an alkyl group having 1˜10 carbon atoms, or a cycloalkyl group, wherein some carbon atoms of the alkyl group or the cycloalkyl group may be replaced by heteroatoms, and among R¹˜R²⁴, alkyl groups substituted on the same N atom may be joined together to form a ring. R² and R³, R⁴ and R⁵, R⁶ and R⁷, R⁸ and R¹ may respectively be joined together to form a ring; R⁹ or R¹⁰, R¹ or R², and R¹¹ or R¹² may respectively be joined together to form a ring; R¹³ or R¹⁴, R³ or R⁴, and R¹⁵ or R¹⁶ may respectively be joined together to form a ring; R¹⁷ or R¹⁸, R⁵ or R⁶ and R¹⁹ or R²⁰ may respectively be joined together to form a ring; R²¹ or R²², R⁷ or R⁸, and R²³ or R²⁴ may respectively be joined together to form a ring; R¹ or R², R³ or R⁴, and R⁵ or R⁶ may respectively be joined together to form a ring; R³ or R⁴, R⁵ or R⁶, and R⁸ or R⁷ may respectively be joined together to form a ring; R⁵ or R⁶, R⁸ or R⁷, and R¹ or R² may respectively be joined together to form a ring; and R⁷ or R⁸, R¹ or R², and R³ or R⁴ may respectively be joined together to form a ring. a˜d are independently 0 or 1. X⁻ is a monovalent anion.)

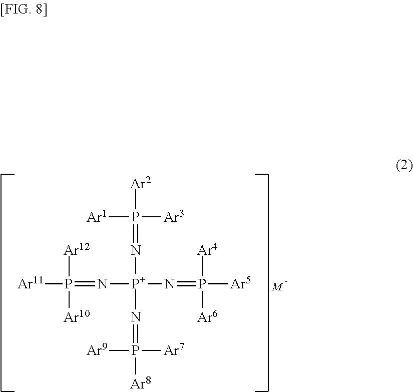

(In formula (2), Ar¹˜Ar¹² each independently represent a substituted or unsubstituted aryl group; M⁻ represents a monovalent anion.)

[19] Compounds represented by any of the following formulas (1a′)˜(1e′).

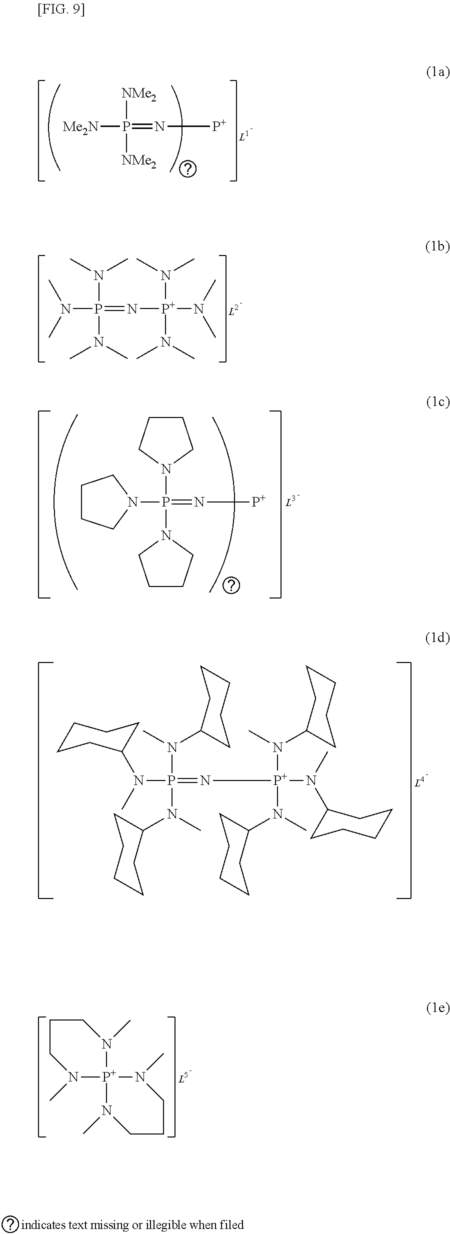

(In formulas (1a′) and (1b′), L¹⁻ and L²⁻ are at least one kind selected from a phenolate ion, a BPA monoanion represented by formula (3a) below, and a BPA monoanion BPA adduct represented by formula (3b) below. In said formulas (1c′)˜(1e′), L³⁻˜L⁵⁻ represent a monovalent anion; Me represents a methyl group.)

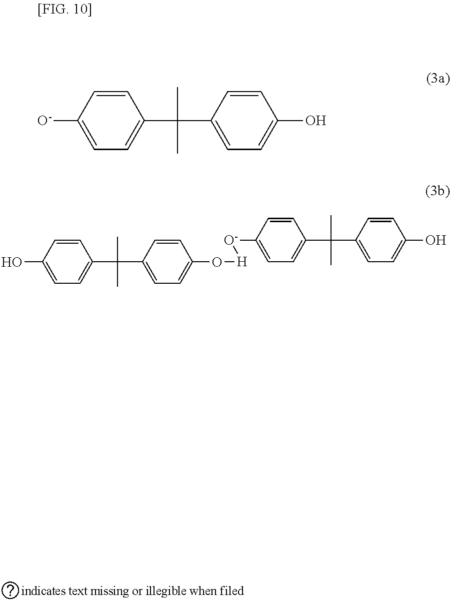

[20] A compound represented by the following formula (2).

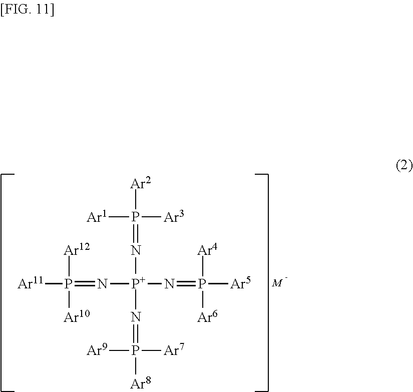

(In formula (2), Ar¹˜Ar¹² each independently represent a substituted or unsubstituted aryl group; M⁻ represents a monovalent anion.)

[21] A polycarbonate produced by the method for producing the thermoplastic resin described in any of [1]˜[17], wherein the viscosity average molecular weight of said polycarbonate is 14,000 or more and 30,000 or less, and the total amount of the compounds represented by the following formulas (A)˜(E) measured in the hydrolysate of the polycarbonate is 300 wt. ppm or more and 550 wt. ppm or less with respect to the polycarbonate resin.

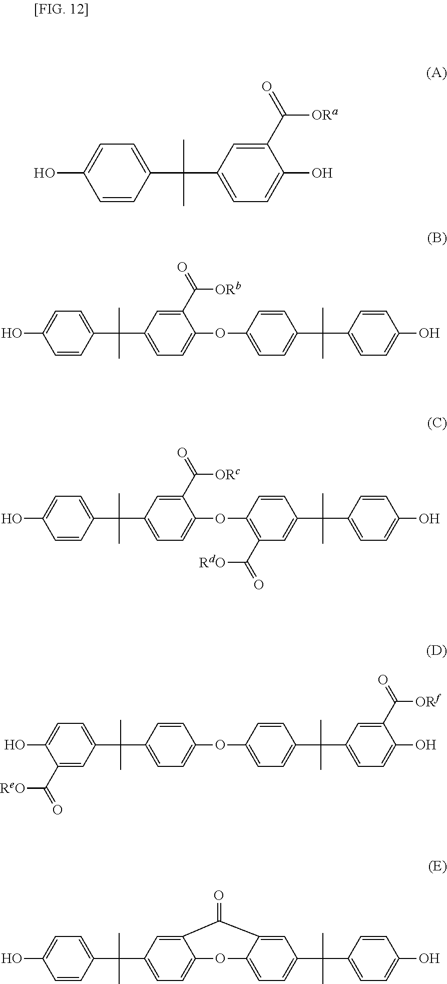

(In formulas (A)˜(D), R^{a}˜R^{f} each independently represent a hydrogen atom or a methyl group. In the benzene rings in formulas (A)˜(E), one or more hydrogen atoms bonded to the benzene rings may be substituted by a substituent.)

[22] The terminal hydroxyl group concentration of said polycarbonate is 400 wt. ppm or more and 1000 wt. ppm or less.

### ADVANTAGES OF THE INVENTION

According to the present invention, by using the compound represented by said formula (1) and/or the compound represented by said formula (2) as the transesterification catalyst for the melt polycondensation reaction, side reactions can be suppressed while maintaining high reactivity with a small addition amount, and the amount of by-products is reduced, resulting in good weather resistance. Specifically, at least one thermoplastic resin selected from the group consisting of a polycarbonate, a polyester, and a polyester carbonate can be produced with good color tone and with less deterioration in hue, transparency, and mechanical strength when used in places exposed to UV and visible light for a long time.

The at least one thermoplastic resin selected from the group consisting of polycarbonate, polyester and polyester carbonate produced by the present invention is suitable for use in automotive materials, electrical and electronic equipment materials, housing materials and parts manufacture in other industrial fields, either as the thermoplastic resin alone, or as a composition suitably compounded with other resins and additives.

The compounds of the present invention have high thermal stability and can be suitably used as transesterification catalysts in the production of various thermoplastic resins.

### DETAILED DESCRIPTION OF THE INVENTION

The present invention will now be described in detail referring to the specific embodiments and examples below. However, the present invention is not particularly limited to these embodiments and examples, and may be implemented with any modification within a scope that does not depart from the spirit of the present invention.

In this specification, “˜” is used in the sense of including the numerical values described before and after it as lower and upper limits, unless otherwise specified.

### 1. SUMMARY

The method for producing at least one thermoplastic resin selected from the group consisting of a polycarbonate, a polyester, and a polyester carbonate (hereinafter may be referred to as “the method for producing a thermoplastic resin of the present invention”) is a method for producing at least one thermoplastic resin selected from the group consisting of a polycarbonate, a polyester, and a polyester carbonate (hereinafter may be referred to as “the method for producing a thermoplastic resin of the present invention”) by melt polycondensation of a dihydroxy compound and a diaryl carbonate and/or a dicarboxylic acid ester, which is an ester-forming compound, in the presence of a transesterification catalyst selected from a compound represented by said formula (1) (hereinafter may be referred to as “Compound (1)”), and/or a compound represented by said formula (2) (hereinafter may be referred to as “Compound (2)”).

Compounds (1) and (2) used as transesterification catalysts in the method for producing a thermoplastic resin of the present invention exhibit polycondensation activity without decomposition or volatilization until the final stage of polycondensation, and their large molecular size allows efficient control of side reactions.

### 2. THERMOPLASTIC RESIN/REACTANTS

### 2-1. Thermoplastic Resin

The thermoplastic resin of the present invention is a thermoplastic resin obtained through the process of melt polycondensation of a dihydroxy compound with a diaryl carbonate and/or dicarboxylic acid ester in the presence of a transesterification catalyst. Specific examples include a polycarbonate, polyester carbonate and polyester. The thermoplastic resin of the present invention is not particularly limited, but polycarbonates are particularly suitable, especially aromatic polycarbonates obtained by melt polycondensation of an aromatic dihydroxy compound and a diaryl carbonate in the presence of said transesterification catalyst.

### 2.2. Dihydroxy Compound

In the method for producing a thermoplastic resin of the present invention, a dihydroxy compound, diaryl carbonate and/or dicarboxylic acid ester are used as raw materials.

The dihydroxy compound includes for example the following compounds, but is not particularly limited thereto.

Dihydroxybiphenyls such as 2,5-dihydroxybiphenyl, 2,2′-dihydroxybiphenyl and 4,4′-dihydroxybiphenyl;

Dihydroxy diaryl ethers such as 2,2′-dihydroxydiphenyl ether, 3,3′-dihydroxydiphenyl ether, 4,4′-dihydroxydiphenyl ether, 4,4′-dihydroxy-3,3′-dimethyldiphenyl ether, 1,4-bis(3-hydroxyphenoxy) benzene and 1,3- bis(4-hydroxyphenoxy)benzene;

Bis(hydroxyaryl)alkanes such as 2,2-bis(4-hydroxyphenyl)propane (hereinafter may be abbreviated as “BPA”), 1,1-bis(4-hydroxyphenyl)propane, 2,2-bis(3-methoxy-4-hydroxyphenyl)propane, 2-(4-hydroxyphenyl)-2-(3-methoxy-4-hydroxyphenyl)propane, 1,1-bis(3-tert-butyl-4-hydroxyphenyl)propane, 2,2-bis(4-hydroxy-3,5-dimethylphenyl)propane, 2,2-bis(3-cyclohexyl-4-hydroxyphenyl)propane, 2-(4-hydroxyphenyl)-2-(3-cyclohexyl-4-hydroxyphenyl)propane, α,α′-bis(4-hydroxyphenyl)-1,4-diisopropylbenzene, 1,3-bis[2-(4-hydroxyphenyl)-2-propyl]benzene, bis(4-hydroxyphenyl)methane, bis(4-hydroxyphenyl) cyclohexylmethane, bis(4-hydroxyphenyl) phenylmethane, bis(4-hydroxyphenyl)(4-propenylphenyl)methane, bis(4-hydroxyphenyl)diphenylmethane, bis(4-hydroxyphenyl) naphthylmethane, 1,1-bis(4-hydroxyphenyl)ethane, 2-bis(4-hydroxyphenyl)ethane, 1,1-bis(4-hydroxyphenyl)-1-phenylethane, 1,1-bis(4-hydroxyphenyl)-1-naphthylethane, 1-bis(4-hydroxyphenyl)butane, 2-bis(4-hydroxyphenyl)butane, 2,2-bis(4-hydroxyphenyl)pentane, 1,1-bis(4-hydroxyphenyl)hexane, 2,2-bis(4-hydroxyphenyl)hexane, 1-bis(4-hydroxyphenyl)octane, 2-bis(4-hydroxyphenyl)octane, 1-bis(4-hydroxyphenyl)hexane, 2-bis(4-hydroxyphenyl)hexane, 4,4-bis(4-hydroxyphenyl)heptane, 2,2-bis(4-hydroxyphenyl)nonane, 10-bis(4-hydroxyphenyl)decane and 1-bis(4-hydroxyphenyl)dodecane;

Bis(hydroxyaryl)cycloalkanes such as 1-bis(4-hydroxyphenyl)cyclopentane, 1-bis(4-hydroxyphenyl)cyclohexane, 4-bis(4-hydroxyphenyl)cyclohexane, 1,1-bis(4-hydroxyphenyl)-3,3-dimethyl cyclohexane, 1-bis(4-hydroxyphenyl)-3,4-dimethylcyclohexane, 1,1-bis(4-hydroxyphenyl)-3,5-dimethylcyclohexane, 1,1-bis(4-hydroxyphenyl)-3,3,5-trimethylcyclohexane, 1,1-bis(4-hydroxy-3,5-dimethylphenyl)-3,3,5-trimethylcyclohexane, 1,1-bis(4-hydroxyphenyl)-3-propyl-5-methylcyclohexane, 1,1-bis(4-hydroxyphenyl)-3-tert-butyl-cyclohexane, 1,1-bis(4-hydroxyphenyl)-3-tert-butyl-cyclohexane, 1,1-bis(4-hydroxyphenyl)-3-phenylcyclohexane and 1,1-bis(4-hydroxyphenyl)-4-phenylcyclohexane;

Bisphenols containing a cardo structure such as 9,9-bis(4-hydroxyphenyl)fluorene and 9,9-bis(4-hydroxy-3-methylphenyl)fluorene;

Dihydroxydiaryl sulfides such as 4,4′-dihydroxydiphenyl sulfide and 4,4′-dihydroxy-3,3′-dimethyldiphenyl sulfide;

Dihydroxydiaryl sulfoxides such as 4,4′-dihydroxydiphenyl sulfoxide and 4,4′-dihydroxy-3,3′-dimethyldiphenyl sulfoxide;

Dihydroxydiarylsulfones such as 4,4′-dihydroxydiphenyl sulfone and 4,4′-dihydroxy-3,3′-dimethyldiphenyl sulfone; and

Aliphatic diols such as isosorbide, 1,4-cyclohexanedimethanol and spiroglycol.

Of these, bisphenol A is preferred as the dihydroxy compound because it reduces the specified by-product content of the resulting thermoplastic resin during melt polycondensation of a diaryl carbonate and/or dicarboxylic acid ester in the presence of a transesterification catalyst selected from compounds (1) and/or (2).

### 2-3. Diaryl Carbonate and Dicarboxylic Acid Ester

In the method for producing a thermoplastic resin of the present invention, a dihydroxy compound, and a diaryl carbonate and/or dicarboxylic acid ester are used as raw materials.

The diaryl carbonate is preferably a compound represented by the following formula (4).

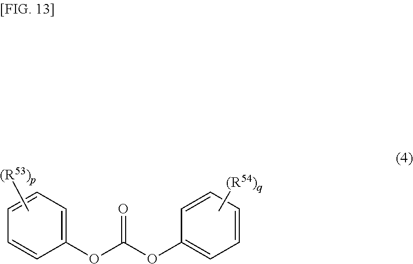

(In formula (4), R⁵³ and R⁵⁴ each independently represent a halogen atom, a nitro group, a cyano group, an alkyl group having 1˜20 carbon atoms, an alkoxycarbonyl group having 1˜20 carbon atoms, a cycloalkyl group having 4˜20 carbon atoms, or an aryl group having 6˜20 carbon atoms. p and q are each independently an integer from 0˜5.)

The diaryl carbonate may be a (substituted) diaryl carbonate such as diphenyl carbonate (hereinafter may be referred to as “DPC”), bis(4-methylphenyl) carbonate, bis(4-chlorophenyl) carbonate, bis(4-fluorophenyl) carbonate, bis(2-chlorophenyl) carbonate, bis(2,4-difluorophenyl)carbonate, bis(4-nitrophenyl)carbonate, bis(2-nitrophenyl)carbonate, bis(methylsalicylphenyl)carbonate, or ditolylcarbonate. Diphenyl carbonate is particularly preferred. These diaryl carbonates can be used alone, or in mixtures of two or more.

The dicarboxylic acid ester may be diphenyl terephthalate or diphenyl isophthalate, but is not particularly limited.

When a diaryl carbonate and dicarboxylic acid ester are used together, the ratio of diaryl carbonate to dicarboxylic acid ester is not particularly limited. The dicarboxylic acid ester is preferably 50 mol % or less, and still more preferably 30 mol % or less with respect to the diaryl carbonate.

### 2-4. Ratio of Dihydroxy Compound to Diaryl Carbonate and/or Dicarboxylic Acid Ester

The ratio of dihydroxy compound raw material to diaryl carbonate and/or dicarboxylic acid ester is arbitrary provided that the desired thermoplastic resin of the present invention is obtained. The diaryl carbonate and/or dicarboxylic acid ester is preferably used in excess of the dihydroxy compound raw material when carrying out polycondensation with the dihydroxy compound. The amount of diaryl carbonate and/or dicarboxylic acid ester used is preferably at least 1.01 times, and more preferably 1.02 times (molar ratio) that of the dihydroxy compound. By setting the molar ratio equal to or above this lower limit, the resulting thermoplastic resin of the present invention has good thermal stability. The amount of diaryl carbonate and/or dicarboxylic acid ester used is preferably 1.30 times or less, and more preferably 1.20 times (molar ratio) or less with respect to the dihydroxy compound. By setting the molar ratio equal to or below the above upper limit, the reactivity is improved, the productivity of the thermoplastic resin of the present invention having the desired molecular weight is better, and the amount of residual carbonate ester in the resin is reduced, thereby suppressing odor generation during the molding process and when the resin is formed into molded products.

### 3. TRANSESTERIFICATION CATALYST

In the method for producing a thermoplastic resin of the present invention, a catalyst selected from a Compound (1) having a specific structure represented by the following formula (1) and/or a Compound (2) having a specific structure represented by the following formula (2) is used as the transesterification catalyst.

As the transesterification catalyst, only one type of Compound (1) may be used, or a mixture of two or more may be used. For Compound (2), only one type may be used, or a mixture of two or more may be used. One or more of Compound (1) and one or more of Compound (2) may also be used in a mixture.

### 3-1. Compound (1)

Compound (1) is represented by the following formula (1).

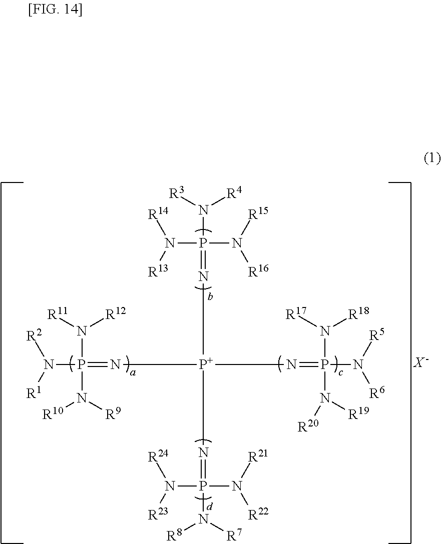

(In formula (1), R¹˜R²⁴ are each independently a hydrogen atom, an alkyl group having 1˜10 carbon atoms, or a cycloalkyl group, wherein some carbon atoms of the alkyl group or the cycloalkyl group may be replaced by heteroatoms, and among R¹˜R²⁴, alkyl groups substituted on the same N atom may be joined together to form a ring. R² and R³, R⁴ and R⁵, R⁶ and R⁷, R⁸ and R¹ may respectively be joined together to form a ring; R⁹ or R¹⁰, R¹ or R², and R¹¹ or R¹² may respectively be joined together to form a ring; R¹³ or R¹⁴, R³ or R⁴, and R¹⁵ or R¹⁶ may respectively be joined together to form a ring; R¹⁷ or R¹⁸, R⁵ or R⁶ and R¹⁹ or R²⁰ may respectively be joined together to form a ring; R²¹ or R²², R⁷ or R⁸, and R²³ or R²⁴ may respectively be joined together to form a ring; R¹ or R², R³ or R⁴, and R⁵ or R⁶ may respectively be joined together to form a ring; R³ or R^{4,} R⁵ or R^{6,} and R⁸ or R⁷ may respectively be joined together to form a ring; R⁵ or R⁶, R⁸ or R⁷, and R¹ or R² may respectively be joined together to form a ring; and R⁷ or R⁸, R¹ or R², and R³ or R⁴ may respectively be joined together to form a ring. a˜d are independently 0 or 1. X⁻ is a monovalent anion.)

It is more preferred that said formula (1) has the structure represented by formula (1B) below. In formula (1B) below, Y⁻ is synonymous with X⁻ in said formula (1).

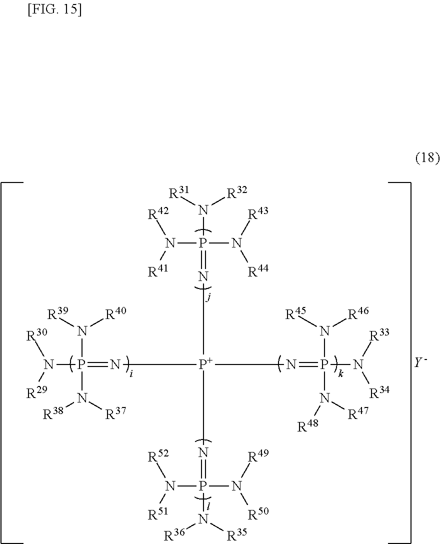

(In formula (1B), R²⁹˜R⁵² are each independently a hydrogen atom or an alkyl group having 1˜10 carbon atoms; among R²⁹˜R⁵², alkyl groups substituted on the same N atom may be joined together to form a ring; R³⁰ and R³¹, R³² and R³³, R³⁴ and R³⁵, and R³⁶ and R²⁹ may respectively be joined together to form a ring. i˜l are independently 0 or 1, respectively; Y⁻ is a monovalent anion.)

In said formula (1), X⁻ is not particularly limited provided that it is a monovalent anion, but it is preferably at least one kind selected from a chloride ion, a bromide ion, a tetraphenylborate ion, a phenolate ion, a BPA monoanion represented by the following formula (3a), and a BPA monoanion BPA adduct represented by the following formula (3b).

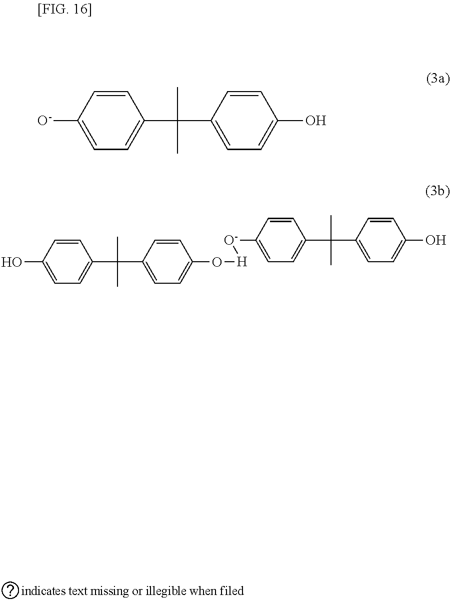

It is particularly preferred that X⁻ is at least one kind selected from a phenolate ion, a BPA monoanion represented by the above formula (3a), and a BPA monoanion BPA adduct represented by the above formula (3b).

Preferred examples of Compound (1) are compounds represented by the following formulas (1a)˜(1e) (hereinafter referred to as “compound (1A)”). In formulas (1a)˜(1e) below, Z⁻ is synonymous with X⁻ in said formula (1).

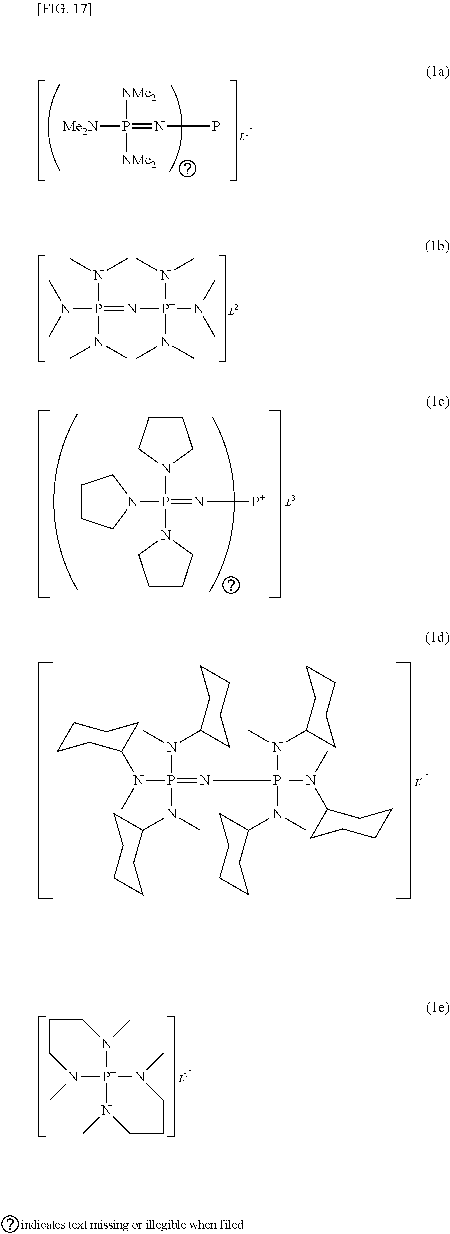

(In formulas (1a)˜(1e), Z¹⁻˜Z⁵⁻ each independently represent a monovalent anion; Me represents a methyl group.)

Specific examples of Compound (1) which are particularly preferred include compounds represented by the following formulas (1a′)˜(1e′), which is the compound (1A) of the present invention.

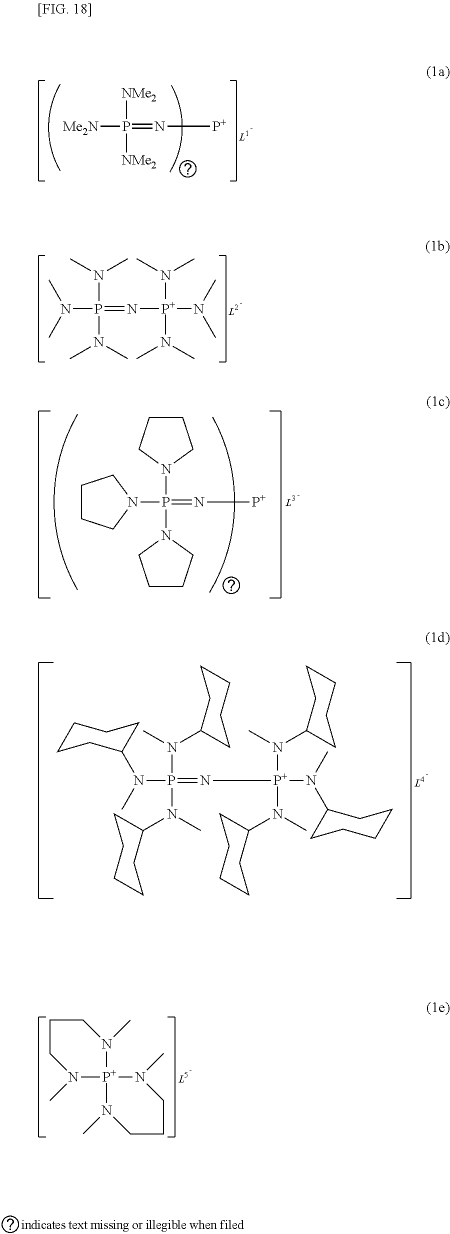

(In formulas (1a′) and (1b′), L¹⁻ and L²⁻ are at least one kind selected from a phenolate ion, a BPA monoanion represented by said formula (3a), and a BPA monoanion BPA adduct represented by said formula (3b). In formulas (1c′)˜(1e′), L³⁻˜L⁵⁻ represent a monovalent anion. The monovalent anion is synonymous with X⁻ in formula (1), and preferred anions are the same. Me represents a methyl group.)

Compound (1) can be obtained or produced by, for example, the following methods. However, the method for producing Compound (1) is not limited thereto.
(i) Compound (1) is produced by using a commercially available organic reagent having a structure other than that of said formula (1) as a raw material.
(ii) An anion of a compound having an anion different from the anion (X⁻) of formula (1) is converted to the anion (X⁻) of said formula (1), and then used.
(iii) The commercially available Compound (1) is used as it is.

### 3-2. Compound (2)

Compound (2) is represented by the following formula (2).

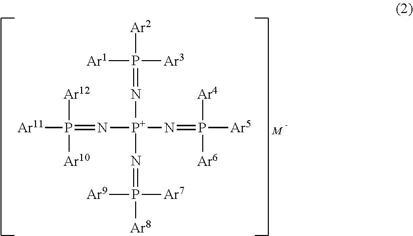

(In formula (2), Ar¹˜Ar¹² are each independently a substituted or unsubstituted aryl group; M⁻ is a monovalent anion.)

In said formula (2), the aryl groups Ar¹˜Ar¹² include a phenyl group, a naphthyl group, and the like. Substituents of the aryl groups Ar¹˜Ar¹² include one or more alkyl groups having 1˜20 carbon atoms and the like. The aryl groups may have only one, or two or more of these substituents. From the viewpoint of thermal stability, it is preferred that each of Ar¹˜Ar¹² is independently an unsubstituted aryl group, particularly an unsubstituted phenyl group.

In said formula (2), M⁻ is not particularly limited provided that it is a monovalent anion, but is preferably at least one kind selected from a chloride ion, a bromide ion, a tetraphenylborate ion, a phenolate ion, a BPA monoanion represented by formula (3a) below, and a BPA monoanion BPA adduct represented by formula (3b), (3c) below. It is more preferably at least one kind selected from a phenolate ion, a BPA monoanion represented by formula (3a) below, and a BPA monoanion BPA adduct represented by formula (3b) below.

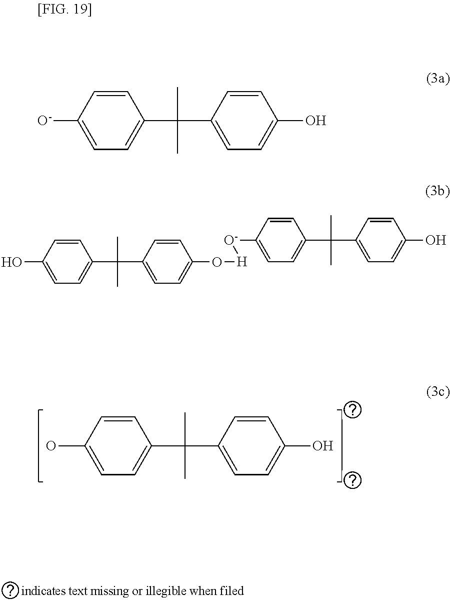

Particularly preferred examples of Compound (2) include the following.

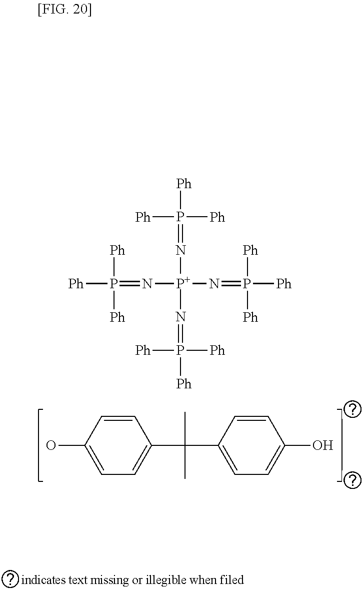

Compound (2) can be obtained or produced by, for example, the following methods. However, the method for producing Compound (2) is not limited thereto.

Compound (2) is produced by the method described in Examples, etc., using commercially available organic reagents as raw materials.

### 3-3. Usage Amount of Transesterification Catalyst

In the method for producing a thermoplastic resin of the present invention, the amount of Compound (1) and/or Compound (2) used as the transesterification catalyst in the melt polycondensation process is not particularly limited, but is preferably 0.01 μmol or more, more preferably 0.1 μmol or more, and still more preferably 1 μmol or more per 1 mol of the dihydroxy compound. By setting the amount equal to or above this lower limit, polymerization activity can be obtained, and the desired thermoplastic resin of the present invention having a predetermined high molecular weight can be obtained. On the other hand, the amount of Compound (1) and/or Compound (2) used is preferably 1000 μmol or less, more preferably 100 μmol or less, still more preferably 50 μmol or less, particularly preferably 10 μmol or less, and most preferably 5 μmol or less per 1 mol of the dihydroxy compound. By setting the amount equal to or below this upper limit, the formation of by-products can be suppressed.

### 3-4. Other Catalyst Components

In the method for producing a thermoplastic resin of the present invention, compounds other than compounds (1) and/or (2) may be used as further catalytic components in addition to compounds (1) and/or (2) as transesterification catalysts to the extent that the effect of the present invention is not significantly hindered. Specifically, a basic compound different from Compound (1) and/or Compound (2) may be further added. Such compounds include at least one or more compounds selected from the group consisting of compounds of Group 1 elements (excluding hydrogen) of the periodic table, compounds of Group 2 elements of the periodic table, basic boron compounds, and basic phosphorus compounds.

Compounds of said Group 1 elements (excluding hydrogen) include inorganic compounds such as hydroxides, carbonates and bicarbonates of Group 1 elements (excluding hydrogen); and organic compounds such as salts of Group 1 elements (excluding hydrogen) with alcohols, phenols and organic carboxylic acids. Group 1 elements (excluding hydrogen) include, for example, lithium, sodium, potassium, rubidium and cesium. Among these compounds of Group 1 elements (excluding hydrogen), cesium compounds are preferred, and cesium carbonate, cesium bicarbonate and cesium hydroxide are particularly preferred.

Compounds of said Group 2 elements include, for example, inorganic compounds such as hydroxides and carbonates of beryllium, magnesium, calcium, strontium and barium; and salts thereof with alcohols, phenols and organic carboxylic acids.

Basic boron compounds include sodium, potassium, lithium, calcium, magnesium, barium and strontium salts of boron compounds. The boron compounds include, for example, tetramethyl boron, tetraethyl boron, tetrapropyl boron, tetrabutyl boron, trimethylethyl boron, trimethylbenzyl boron, trimethylphenyl boron, triethylmethyl boron, triethylbenzyl boron, triethylphenyl boron, tributyl benzyl boron, tributyl phenyl boron, tetraphenyl boron, benzyl triphenyl boron, methyl triphenyl boron, and butyl triphenyl boron.

Basic phosphorus compounds include, for example, trivalent phosphorus compounds such as triethylphosphine, tri-n-propylphosphine, triisopropylphosphine, tri-n-butylphosphine, triphenylphosphine, tri-butylphosphine, triphenylphosphine, and tri-t-butylphenylphosphine.

In the method for producing a thermoplastic resin of the present invention, the ratio of catalytic compounds other than Compound (1) and/or Compound (2), which may be included as a component of the catalyst, is usually in the range of 10000:1˜3:1, preferably in the range of 5000:1˜5:1, and more preferably in the range of 1000:1˜10:1, in terms of Compound (1) and/or Compound (2): other catalytic compounds (molar ratio). The above range is preferred because the formation of by-products can be suppressed.

### 3-5. Method of Adding Transesterification Catalyst

In the method for producing a thermoplastic resin of the present invention, any method can be used to add the aforementioned transesterification catalyst. The transesterification catalyst may be mixed directly with the dihydroxy or ester-forming compounds which are the raw materials, or dissolved in a solvent beforehand and used as a dilute solution. Using the catalyst as a dilute solution improves feed precision and dispersibility in the raw material. The solvent and catalyst concentration used is not particularly limited, and can be selected according to solubility. Examples of solvents include water, phenol, acetone, alcohol, toluene, ether, and tetrahydrofuran. When water is used as a solvent, the properties of the water are not particularly limited provided that the type and concentration of impurities contained are constant. Usually, distilled water or deionized water is preferably used. The transesterification catalyst may be added during polymerization.

### 4. METHOD FOR PRODUCING THERMOPLASTIC RESIN

The method for producing a thermoplastic resin of the present invention is performed by mixing said dihydroxy compound, diaryl carbonate and/or dicarboxylic acid ester as raw materials, and subjecting this raw material mixture to a polycondensation reaction in a polycondensation reactor in the presence of said transesterification catalyst. The polycondensation process can be performed as a batch process, a continuous process, or a combination of both. After the polycondensation process, the thermoplastic resin of the present invention is produced by stopping the reaction, followed by a step of removing unreacted raw materials and reaction by-products from the polymerization reaction solution by volatilization, a step of adding a heat stabilizer or mold release agent, and a step of forming pellets of a predetermined particle diameter as required.

The polycondensation process is usually carried out continuously in a multi-stage system of two or more stages, preferably three˜seven stages. Specific reaction conditions are usually in the range of temperature: 150° C.˜350° C., pressure: ambient pressure ˜0.01 Torr (1.3 Pa), and average residence time: 5˜150 minutes.

In the multi-stage method, the polycondensation reaction apparatus is set to higher temperatures and higher degrees of vacuum in stages within said reaction conditions in order to more effectively remove phenolic by-products outside the system as the polycondensation reaction proceeds.

In order to prevent deterioration in quality such as the hue of the resulting thermoplastic resin of the present invention, it is preferable to set the reaction temperature as low as possible and the residence time as short as possible. From this perspective, the reaction temperature is preferably set at 150° C.˜320° C.

When the polycondensation process is carried out in a multi-stage system, multiple reactors, including vertical reactors, are usually installed to increase the average molecular weight of the thermoplastic resin of the present invention. Three˜six reactors are usually installed, preferably four˜five.

Examples of reactors include a stirred tank reactor, thin film reactor, centrifugal thin film evaporation reactor, surface renewal type twin-screw kneading reactor, twin-screw horizontal stirred reactor, wet wall reactor, porous plate reactor which polymerizes while the reactants are in free fall, a porous plate reactor with wires which polymerizes while the reactants are in free fall along the wires, and the like.

Examples of stirrer blades for vertical reactors include turbine blades, paddle blades, Pfaudler blades, anchor blades, full-zone blades (manufactured by Shinko Pantec Co., Ltd.), Sunmeller blades (manufactured by Mitsubishi Heavy Industries, Ltd.), Maxblend blades (manufactured by Sumitomo Heavy Industries, Ltd.), helical ribbon blades, and torsional lattice blades (manufactured by Hitachi, Ltd.).

A horizontal reactor is one in which the rotation axis of the stirrer blades is horizontal (in the horizontal direction). Examples of stirrer blades for horizontal reactors include uniaxial type stirrer blades such as disk type and paddle type, and biaxial type stirrer blades such as HVR, SCR, N-SCR (manufactured by Mitsubishi Heavy Industries, Ltd.), Vivolak (manufactured by Sumitomo Heavy Industries, Ltd.), or spectacle blades and lattice blades (manufactured by Hitachi, Ltd.).

### 5. PHYSICAL PROPERTIES OF THERMOPLASTIC RESIN

The molecular weight of the thermoplastic resin of the present invention obtained by the method for producing a thermoplastic resin of the present invention is not particularly limited, and may be selected and determined as appropriate. The viscosity average molecular weight [Mv] of the thermoplastic resin of the present invention calculated from the solution viscosity is usually 5,000 or more, preferably 10,000 or more, but more preferably 15,000 or more; and usually 40,000 or less, preferably 30,000 or less, but more preferably 24,000 or less. By setting the viscosity average molecular weight equal to or above the lower limit of said range, the mechanical strength of the thermoplastic resin of the present invention can be further improved, which is more desirable when used in applications that require high mechanical strength. By setting the viscosity average molecular weight equal to or below the upper limit of said range, the decrease in flowability of the thermoplastic resin of the present invention can be suppressed, and as its moldability is thereby enhanced, it can be easily molded.

Viscosity average molecular weight [Mv] means the value calculated from the Schnell viscosity formula, i.e., η=1.23×10⁻⁴ Mv^{0.83}, using methylene chloride as the solvent and determining the limiting viscosity [η] (unit: dl/g) at a temperature of 20° C. using a Ubbelohde viscometer. The limiting viscosity [η] is the value calculated by measuring the specific viscosity [ηₛₚ] at each solution concentration [C] (g/dl), and using the following formula.

$$η = {lim}_{c \to 0} {η}_{sp} / c \qquad [ Math . 1 ]$$

The terminal hydroxyl group concentration of the thermoplastic resin of the present invention is not particularly limited, but is preferably 1500 ppm or less, more preferably 1000 ppm or less, still more preferably 800 ppm or less, and particularly preferably 600 ppm or less. As the terminal hydroxyl group concentration becomes lower, the thermal stability of the thermoplastic resin of the present invention to accumulated heat tends to further improve. The terminal hydroxyl group concentration of the thermoplastic resin of the present invention is preferably 50 ppm or more, more preferably 100 ppm or more, still more preferably 150 ppm or more, and particularly preferably 200 ppm or more. As the terminal hydroxyl group concentration increases, the color tone tends to improve.

The unit of terminal hydroxyl group concentration is the weight of terminal hydroxyl groups expressed in ppm with respect to the weight of the thermoplastic resin of the present invention. The measurement method is colorimetric determination by titanium tetrachloride/acetic acid (described in Macromol. Chem. 88 215 (1965)).

When bisphenol A is used as the raw material dihydroxy compound, the resulting thermoplastic resin of the present invention may contain by-products as shown, for example, by formulas (A)˜(E) below, upon hydrolysis. The presence of these by-products means that the structural units of the resulting thermoplastic resin contain hetero-bonded structural units derived from bisphenol A.

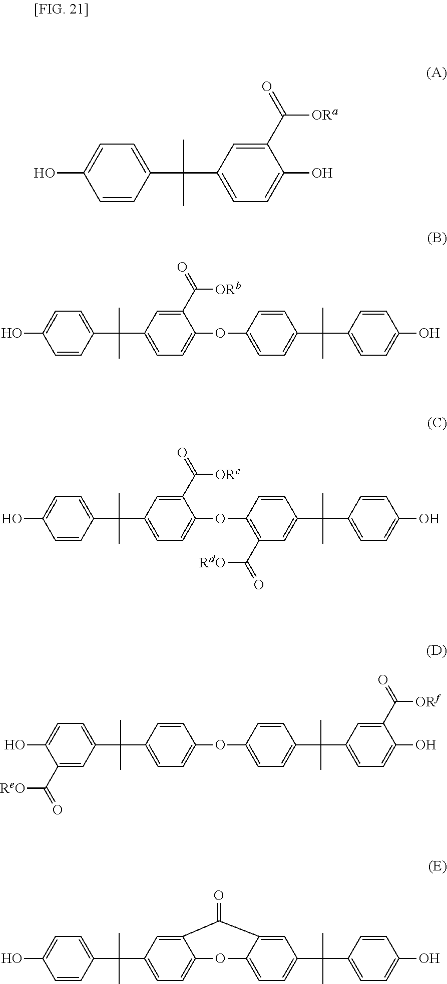

In formulas (A)˜(D), R^{a}˜R^{f} each independently represent a hydrogen atom or a methyl group. In the benzene rings in formulas (A)˜(E), one or more hydrogen atoms bonded to the benzene rings may be substituted by substituents such as an alkyl group having 1˜5 carbon atoms, an alkoxy group having 1˜10 carbon atoms, a phenyl group, a vinyl group, a cyano group, an ester group, an amide group, or a nitro group.

The content of these by-products can be determined by analyzing the thermoplastic resin of the present invention after hydrolysis. The total amount of the by-products represented by the above formulas (A)˜(E) is preferably 1000 ppm or less, more preferably 800 ppm or less, and still more preferably 600 ppm or less with respect to the total thermoplastic resin obtained before hydrolysis. If the total amount of by-products is kept within the above range, the thermoplastic resin of the present invention has excellent color tone and lightfastness. On the other hand, although it would be preferable that the total amount of by-products represented by the above formulas (A)˜(E) were 0 ppm, if it is reduced too much, it lowers the polymerization activity and the reaction must be carried out for a long time, which results in deterioration of color tone. Therefore, from the viewpoint of product color tone, the amount is normally set to 100 ppm or more.

The thermoplastic resin of the present invention has good color tone, specifically, the pellet YI is usually 15 or less, preferably 10 or less, and still more preferably 8 or less. By using a thermoplastic resin with such a pellet YI, coloring and brightness when colored are improved, and the degree of freedom in product design is enhanced.

The pellet YI was evaluated by measuring the YI value (yellow index value) in the reflected light of pellets of thermoplastic resin according to ASTM D1925. A Konica Minolta CM-5 spectrophotometer was used as the instrument, and the measurement conditions were selected as follows: measurement diameter of 30 mm and SCE. A CM-A212 calibration glass for Petri dish measurement was inserted into the measuring section, and a CM-A124 zero calibration box was placed over it for zero calibration, followed by white calibration using the built-in white calibration plate. Measurement was performed using the CM-A210 white calibration plate, and it was confirmed that L* was 99.40+0.05, a* was 0.03+0.01, b* was -0.43+0.01, and YI was -0.58+0.01. The pellets were measured by filling a cylindrical glass container having an inner diameter of 30 mm and a height of 50 mm to a depth of approx. 40 mm with pellets. The pellets were removed from the glass container, measured again twice, and the average of three measurements was taken.

The smaller the YI value, the less yellowish the resin and the better the color tone.

### 6. THERMOPLASTIC RESIN COMPOSITION

The thermoplastic resin of the present invention may, if necessary, be blended with a polycarbonate resin or polyester resin other than the thermoplastic resin of the present invention, i.e., other than the at least one thermoplastic resin selected from the group consisting of a polycarbonate, a polyester, and a polyester carbonate produced by the method for producing a thermoplastic resin of the present invention, or other components such as various resin additives may be blended together and used as a thermoplastic resin composition. One or more of said other components may be included in any combination and ratio.

The other resins include, for example, polyolefin resin such as polyethylene resin and polypropylene resin; polyamide resin; polyimide resin; polyetherimide resin; polyurethane resin; polyphenylene ether resin; polyphenylene sulfide resin; polysulfone resin; polymethacrylate resin, and the like.

One of the other resins may be included, or two or more may be included in any combination and ratio.

The resin additives include, for example, heat stabilizers, antioxidants, UV absorbers, mold release agents, lubricants, dyes, antistatic agents, antifogging agents, antiblocking agents, flow modifiers, plasticizers, dispersants, antibacterial agents, impact modifiers and flame retardants, reinforcing agents such as glass fiber and carbon fiber, and fillers such as talc, mica and silica. One resin additive may be included, or two or more may be included in any combination and ratio.

### 7. COMPOUNDS OF THE PRESENT INVENTION

### 7-1. Compound (1A) of the Present Invention

Compound (1A) of the present invention is represented by any of the following formulas (1a′)˜(1e′).

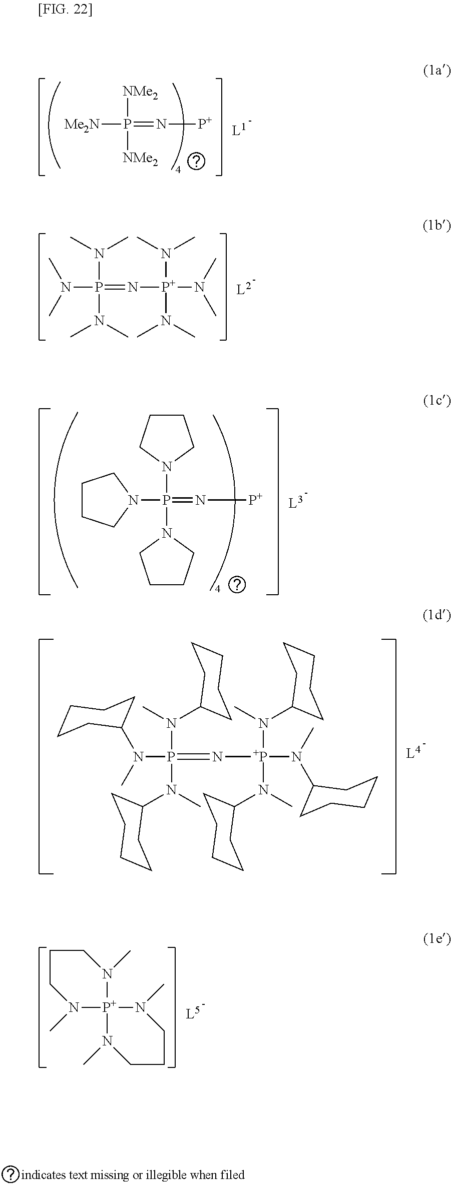

(In formulas (1a′) and (1b′), L¹⁻ and L²⁻ are at least one kind selected from a phenolate ion, a BPA monoanion represented by the formula (3a) below, and a BPA monoanion BPA adduct represented by the formula (3b) below. In formulas (1c′)˜(1e′), L³⁻˜L⁵⁻ represent a monovalent anion. The monovalent anion is synonymous with X⁻ in formula (1), and preferred anions are the same. Me represents a methyl group.)

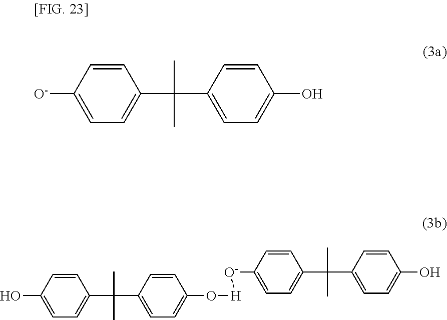

In formula (1c′), L³⁻ is preferably at least one kind selected from a chloride ion, a bromide ion, a tetraphenylborate ion, a phenolate ion, a BPA monoanion represented by formula (3a), and a BPA monoanion BPA adduct represented by formula (3b), but is more preferably at least one kind selected from a phenolate ion, a BPA monoanion represented by formula (3a), and a BPA monoanion BPA adduct represented by formula (3b).

In formula (1d′), L⁴⁻ is preferably at least one kind selected from a chloride ion, a bromide ion, a tetraphenylborate ion, a phenolate ion, a BPA monoanion represented by formula (3a), and a BPA monoanion BPA adduct represented by formula (3b), but is more preferably at least one kind selected from a phenolate ion, a BPA monoanion represented by formula (3a), and a BPA monoanion BPA adduct represented by formula (3b).

In formula (1e′), L⁵⁻ is preferably at least one kind selected from a chloride ion, a bromide ion, a tetraphenylborate ion, a phenolate ion, a BPA monoanion represented by formula (3a), and a BPA monoanion BPA adduct represented by formula (3b), but is more preferably at least one kind selected from a phenolate ion, a BPA monoanion represented by formula (3a), and a BPA monoanion BPA adduct represented by formula (3b).

Compound (1A) of the present invention represented by formulas (1a′)˜(1e′) is particularly useful as a transesterification catalyst in the method for producing a thermoplastic resin of the present invention, i.e., as a transesterification catalyst of the present invention.

### 7-2. Compound (2) of the Present Invention

Compound (2) of the present invention is the aforementioned Compound (2) represented by the following formula (2).

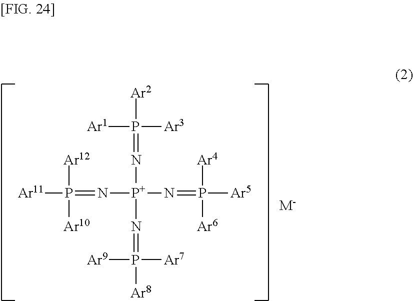

(In formula (2), Ar¹˜Ar¹² are each independently a substituted or unsubstituted aryl group; M⁻ is a monovalent anion.)

In said formula (2), the aryl groups Ar¹˜Ar¹² include a phenyl group, a naphthyl group, and the like. Substituents of the aryl groups Ar¹˜Ar¹² include one or more alkyl groups having 1˜20 carbon atoms and the like. The aryl groups may have only one, or two or more of these substituents. From the viewpoint of thermal stability, it is preferred that each of Ar¹˜Ar¹² is independently an unsubstituted aryl group, particularly an unsubstituted phenyl group.

In said formula (2), M⁻ is not particularly limited provided that it is a monovalent anion, but is preferably at least one kind selected from a chloride ion, a bromide ion, a tetraphenylborate ion, a phenolate ion, a BPA monoanion represented by formula (3a) below, and a BPA monoanion BPA adduct represented by formulas (3b), (3c) below. It is preferably at least one kind selected from a phenolate ion, a BPA monoanion represented by formula (3a) below, and a BPA monoanion BPA adduct represented by formula (3b) below.

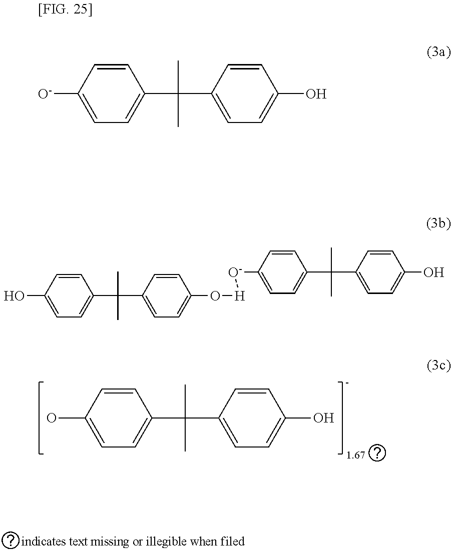

Specific examples of Compound (2) of the present invention represented by formula (2) are those listed above as specific examples of Compound (2).

Compound (2) of the present invention represented by formula (2) is particularly useful as a transesterification catalyst in the method for producing a thermoplastic resin of the present invention, i.e., as a transesterification catalyst of the present invention.

### 8. POLYCARBONATE

The polycarbonate of the present invention is a polycarbonate produced by the method for producing a thermoplastic resin of the present invention, wherein the viscosity average molecular weight [Mv], as defined above, is 14,000 or more and 30,000 or less, wherein the total amount of the compounds represented by the following formulas (A)˜(E) (hereinafter referred to as “specified compounds”) measured in the hydrolysate of the polycarbonate is 300 wt. ppm or more, and less than or equal to 550 wt. ppm with respect to the polycarbonate resin.

The viscosity average molecular weight [Mv] of the solution viscosity of the polycarbonate of the present invention is preferably 15,000 or more, more preferably 18,000 or more, preferably 29,000 or less, and more preferably 23,000 or less. By setting the viscosity average molecular weight equal to or above the lower limit of said range, the mechanical strength of the polycarbonate of the present invention can be further improved, which is more desirable when used in applications that require high mechanical strength. By setting the viscosity average molecular weight equal to or below the upper limit of said range, the decrease in flowability of the polycarbonate of the present invention can be suppressed, and as its moldability is thereby enhanced, it can be easily molded.

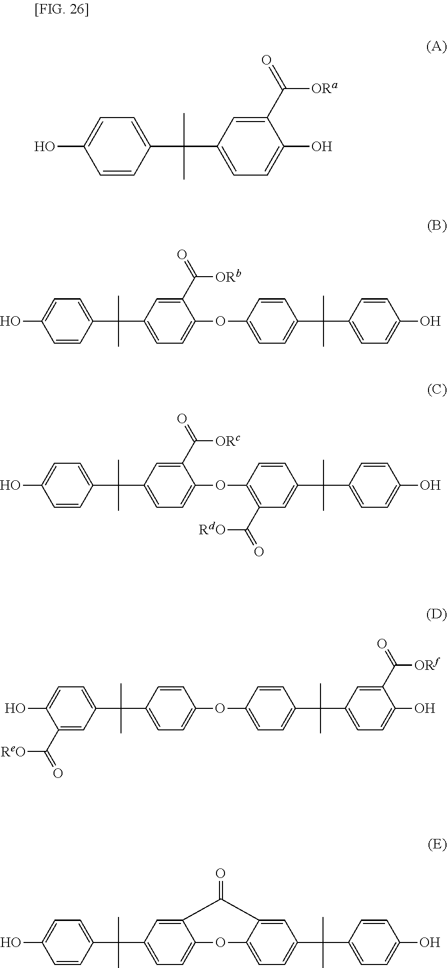

In formulas (A)˜(D), R^{a}˜R^{f} each independently represent a hydrogen atom or a methyl group. In the benzene rings in formulas (A)˜(E), one or more hydrogen atoms bonded to the benzene rings may be substituted by substituents such as an alkyl group having 1˜5 carbon atoms, an alkoxy group having 1˜10 carbon atoms, a phenyl group, a vinyl group, a cyano group, an ester group, an amide group, or a nitro group.

As mentioned above, the amount of the specified compounds can be determined by analyzing the polycarbonate of the present invention after hydrolysis. More preferably, the total amount of the specified compounds is 500 ppm or less of the total polycarbonate obtained before hydrolysis. By keeping the total amount of the specified compounds within the above range, the polycarbonate of the present invention has good color tone and lightfastness. On the other hand, although it would be preferable that the total amount of the specified compounds was 0 ppm, if it is reduced too much, the polymerization activity declines and the reaction must be carried out for a long time, resulting in a deterioration of color tone. Therefore, from the viewpoint of product color tone, the content of the specified compounds is normally set to 100 ppm or more.

The terminal hydroxyl group concentration of the polycarbonate of the present invention is not particularly limited, but is preferably 1000 ppm or less, more preferably 800 ppm or less, still more preferably 700 ppm or less, and particularly preferably 600 ppm or less. As the terminal hydroxyl group concentration becomes lower, the stability of the polycarbonate of the present invention to accumulated heat tends to further improve. The terminal hydroxyl group concentration of the polycarbonate of the present invention is preferably 250 ppm or higher, more preferably 300 ppm or higher, still more preferably 350 ppm or higher, and particularly preferably 400 ppm or higher. As the terminal hydroxyl group concentration increases, the color tone tends to improve.

### EXAMPLES

The following examples are provided to describe the present invention in more detail. However, the present invention is not limited to the following examples and can be implemented with any modification within the scope that does not depart from the spirit of the present invention.

### Evaluation

First, the measurement method for each evaluation will be described.

### (1) Thermal Stability Test of Catalyst Compounds

10 mg of catalyst and 30 mg of DPC were mixed, added to a J. YOUNG NMR sample tube with a valve attached, and sealed under an argon atmosphere. The J. YOUNG NMR sample tube with a valve attached was heated in an oil bath at 220° C. for 105 minutes, from 220° C. to 290° C. for 20 minutes, and then at 290° C. for 1 hour. The heat-treated samples were then cooled to room temperature and dissolved in DMSO-d6.

³¹P NMR was measured a cumulative total of 512 times, and the decomposition rate of the catalyst was calculated based on the integrals of the obtained spectra as the mass % of catalyst reduced after heating compared to 100% of the mass of catalyst before heat treatment.

### (2) Viscosity Average Molecular Weight (Mv) of Thermoplastic Resin

The thermoplastic resin was dissolved in methylene chloride (concentration 6.0 g/L), and the intrinsic viscosity (limiting viscosity) [η] (unit: dL/g) at 20° C. was determined using a Ubbelohde viscosity tube (Moritomo Rika Kogyo Co., Ltd.). The viscosity average molecular weight (Mv) was calculated from the Schnell viscosity formula (below).

η=1.23×10⁻⁴Mv^{0.83}

### (3) Terminal Hydroxyl Group Content of Thermoplastic Resin

The terminal hydroxyl group content of the thermoplastic resin was measured by colorimetric determination using titanium tetrachloride/acetic acid by the method described below.

### (a) Preparation of 5 v/v % Acetic Acid Solution

A 5 v/v % acetic acid solution was prepared by adding 50 mL of acetic acid to a 1000 mL volumetric flask, and filling up to the graduation with methylene chloride to mix.

### (b) Preparation of Titanium Tetrachloride Solution

A titanium tetrachloride solution was prepared by adding 90 mL of methylene chloride to a 300 mL flask with a measuring cylinder, adding 10 mL of 5 v/v % acetic acid solution with a measuring cylinder, and while stirring with a magnetic stirrer, slowly adding 2.5 mL of titanium tetrachloride solution and 2.0 mL of methanol with a 5 mL graduated pipette.

### (c) Preparation of Calibration Curve Samples

A methylene chloride solution was prepared so that the amount of terminal hydroxyl groups of the dihydroxy compound raw material was 10 wt. ppm, and 0, 3, and 5 mL were added sequentially to a 25 mL volumetric flask. Next, 5 mL of 5 v/v % acetic acid and 10 mL of titanium tetrachloride solution were added. The flask was filled up to the graduation with methylene chloride, and the contents were mixed well.

### (d) Preparation of Calibration Curve

The absorbance of each of the prepared calibration samples was measured at a detection wavelength of 546 nm. The absorbance obtained was plotted against the concentration of the calibration sample. The reciprocal of this slope was used as a factor.

### (e) Sample Preparation and Absorbance Measurement

0.2 g of the thermoplastic resin and 5 mL of methylene chloride were dissolved in a 25 mL volumetric flask. Next, 5 mL of 5 v/v % acetic acid solution and 10 mL of titanium tetrachloride solution were added, the flask was filled up to the graduation with methylene chloride, and the contents were mixed well. The absorbance of the prepared solution was measured at a detection wavelength of 546 nm.

### (f) Calculation of Amount of Terminal Hydroxyl Groups

The amount of terminal hydroxyl groups in the thermoplastic resin was calculated by dividing the product of the measured absorbance and the factor by the concentration of the sample.

### (4) Content of By-Products (Specified Compounds) Represented by Formulas (A)˜(E) in the Thermoplastic Resin

After dissolving 0.5 g of the thermoplastic resin in 5 ml of methylene chloride, 45 ml of methanol and 5 ml of 25 wt % aqueous sodium hydroxide solution were added, and the solution hydrolyzed by stirring at 70° C. for 30 minutes (methylene chloride solution). Then, 6N hydrochloric acid was added to the methylene chloride solution to make the pH of the solution approx. 2, and the solution was made up to 100 mL with pure water.

Next, 20 μl of the prepared methylene chloride solution was injected into a liquid chromatography apparatus, and the content of the compounds represented by said formulas (A)˜(E) was measured (units: ppm), and taken as the content of the specified compounds which are by-products.

The liquid chromatography apparatus and measurement conditions were as follows.
Liquid chromatography apparatus: Shimadzu Corporation LC-10AD
Column: YMC PACK ODS-AM M-307-3, 4.6 mm ID×75 mmL
Detector: UV 280 nm
Eluents: (A) 0.05% aqueous trifluoroacetic acid solution, (B) Methanol
Gradient conditions: 0 min (B=40%), 25 min (B−95%)

The content of the specified compounds represented by formulas (A)˜(E) was calculated from the respective peak areas based on a calibration curve prepared using bisphenol A.

### Description of Symbols

In the following, the abbreviations of substituents, etc., in the raw materials and compounds used are as follows.
BPA: Bisphenol A (Mitsubishi Chemical Corporation)
DPC: Diphenyl carbonate (Mitsubishi Chemical Corporation)
THF: Tetrahydrofuran
DCM: Dichloromethane
Ph: Phenyl
Ad: Adamantyl
imy: Imidazole
Et: Ethyl
Me: Methyl
Mes: Mesityl
Pr: Propyl
BPA₂: BPA monoanion BPA adduct represented by said formula (3b)

### Synthesis of Catalyst Compound

### Synthesis Example 1: Preparation of BPA Monoanion BPA Adduct

The corresponding compounds were dissolved in the minimum volume of a THF and methanol mixed solvent (v/v=4:1) to obtain a compound solution.

Separately, K-BPA₂ was synthesized (in situ) by adding potassium tert-butoxide (Sigma-Aldrich) and bisphenol A to a THF and methanol mixed solvent (v/v=4:1).

This K-BPA₂ was added dropwise to said compound solution at room temperature. The reaction solution was stirred for 2 hours, and then filtered to remove precipitated inorganic salts. The solvent in the filtrate was removed by a rotary evaporator, and the residue was recrystallized from isopropanol to give the pure product.

### Example 1: Synthesis of Catalyst A

388 mg (0.50 mmol) of tetrakis[tris(dimethylamino)phosphoranylidene amino]phosphonium chloride (hereinafter may be abbreviated as P5-Cl) (Sigma-Aldrich) was treated according to Synthesis Example 1 to give Catalyst A represented by the following structural formula (hereinafter may be abbreviated as P5-BPA₂) in 53% yield.

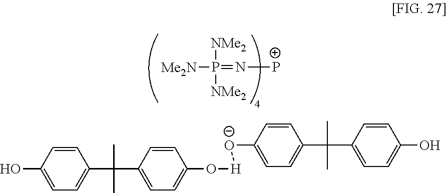

Structural identification by NMR (nuclear magnetic resonance) was as follows.

¹H NMR (400 MHZ, 298 K, d₆-DMSO) δ 6.82, 6.48 (each d, ³J_{H-H}=7.6 Hz, each 8H, BPA-H), 2.57 (d, ³J_{H-P}=12.0 Hz, 72H, N—CH₃), 1.47 (s, 12H, and BPA-CH₃).

¹³C {H} NMR (100 MHZ, 298 K, d₆-DMSO) δ 158.4, 138.3, 126.9, 115.3, 40.5, 36.6, 31.3.

³¹P {H} NMR (162 MHZ, 298 K, d₆-DMSO) δ 6.7 (d, ²J_{P-P}=51.8 Hz), −34.1 (quintet, ²J_{P-P}=51.8 Hz)

The result of elemental analysis showed calculated values of C₅₄H₁₀₃N₁₆O₄P₅: C54.26, H8.69, N18.75, whereas the measured values were C54.13, H8.72, N18.64.

The result of a thermal stability test of the compound obtained is shown in Table 1.

### Example 2: Synthesis of Catalyst B

P5-Cl (0.42 g, 0.54 mmol) was dissolved in 5 mL of THF. Next, sodium phenoxide (0.063 g, 0.54 mmol) was added under an argon atmosphere, the reaction mixture was stirred at room temperature for 3 hours, and the precipitate was removed by filtration. The solvent in the filtrate was then removed by a rotary evaporator. The residue was washed with ether and dried under vacuum to give Catalyst B (hereinafter may be abbreviated as P5-OPh) quantitatively represented by the following structural formula.

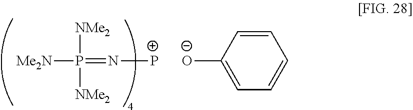

Structural identification by NMR (nuclear magnetic resonance) was as follows.

¹H NMR (400 MHZ, 298 K, d₆-DMSO) δ 6.83 (t, ³J_{H-H}=8.0 Hz, 2H, Ph-H) 6.37 (d, ³J_{H-H}=8.0 Hz, 2H, Ph-H), 6.16 (t, ³J_{H-H}=8.0 Hz, 1H, Ph-H), 2.58 (d, ³J_{H-P}=12.0 Hz, 72H, N—CH₃).

¹³C {H} NMR (100 MHz, 298 K, d₆-DMSO) δ 128.6, 117.4, 36.6.

³¹P {H} NMR (162 MHZ, 298 K, d₆-DMSO) δ 6.7 (d, ²J_{P-P}=53.4 Hz), −34.1 (quintet, ²J_{P-P}=53.4 Hz)

The result of elemental analysis showed calculated values of C₃₀H₇₇N₁₆OP₅: C43.26, H9.32, N26.91, whereas the measured values were C42.79, H9.13, N26.97.

The result of a thermal stability test of the compound obtained is shown in Table 1.

### Example 3: Synthesis of Catalyst C

0.31 g (0.41 mmol) of P5-Cl (Sigma-Aldrich) was dissolved in 5 mL of dichloromethane, then 0.14 g (0.41 mmol) of sodium tetraphenylborate (Sigma-Aldrich) was added. The reaction mixture was stirred overnight at room temperature, and the sodium chloride formed was removed by filtration. The dichloromethane in the filtrate was removed by a rotary evaporator. The residue was heated and refluxed in 10 mL of ethanol for 30 minutes. After cooling to room temperature, the precipitated white crystals were isolated by filtration and dried under vacuum to give Catalyst C represented by the following structural formula (hereinafter may be abbreviated as P5-BPh₄) in 99% yield.

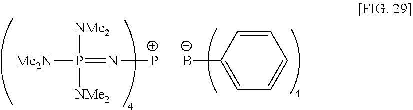

Structural identification by NMR (nuclear magnetic resonance) was as follows.

¹H NMR (400 MHZ, 298 K, CD₂Cl₂) δ 7.31 (m, 8H, Ph-H) 7.03 (t, ³J_{H-H}=7.6 Hz, 8H, Ph-H), 6.88 (t, ³J_{H-H}=7.6 Hz, 4H, Ph-H), 2.61 (d, ³J_{H-P}=8.0 Hz, 72H, N—CH₃).

¹³C {H} NMR (100 MHZ, 298 K, CD₂Cl₂) δ 164.5 (m), 136.3 (d), 126.0 (m), 122.1, 37.2 (d).

³¹P {H} NMR (162 MHZ, 298 K, CD₂Cl₂) δ 6.3 (d, ²J_{P-P}=55.0 Hz), −34.7 (quintet, ²J_{P-P}=55.0 Hz).

The result of elemental analysis showed calculated values of C₄₈H₉₂BN₁₆P₅: C54.44, H8.76, whereas the measured values were C54.31, H8.67, N21.27.

### Example 4: Synthesis of Catalyst D

0.43 g (1.0 mmol) of bis[tris(dimethylamino)phosphoranylidene] ammonium tetrafluoroborate (hereinafter may be abbreviated as P2-BF₄) (Sigma-Aldrich) was treated according to Synthesis Example 1 to give Catalyst D represented by the following structural formula (hereinafter may be abbreviated as P5-BPA₂) in 94% yield.

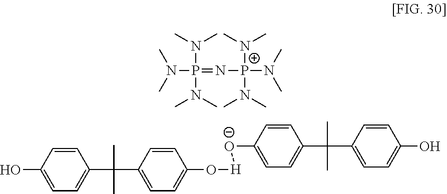

Structural identification by NMR (nuclear magnetic resonance) was as follows.

¹H NMR (400 MHZ, 298 K, d₆-DMSO) δ 6.82, 6.49 (each d, ³J_{H-H}=7.6 Hz, each 8H, BPA-H), 2.60 (m, 36H, N—CH₃), 1.48 (s, 12H, BPA-CH₃).

¹³C {H} NMR (100 MHZ, 298 K, d₆-DMSO) δ 158.5, 138.3, 126.9, 115.3, 40.5, 36.2, 31.1.

³¹P {H} NMR (162 MHZ, 298 K, d₆-DMSO) δ 17.5.

The result of elemental analysis showed theoretical calculated values of C₄₂H₆₇N₇O₄P₂: C63.38, H8.48, N12.32, whereas the measured values were C63.21, H8.35, N12.46.

The result of a thermal stability test of the compound obtained is shown in Table 1.

### Example 5: Synthesis of Catalyst E

1.14 g (1.0 mmol) of tetrakis[(tri-1-pyrrolidinylphosphoranylidene) amino]phosphonium tetrafluoroborate (hereinafter may be abbreviated as P5(pyr)-BF₄) (Chem. Eur. J. 2006, 12, 429-437) was treated according to Synthesis Example 1 to give Catalyst E represented by the following structural formula (hereinafter may be abbreviated as P5(pyr)-BPA₂) in 83% yield.

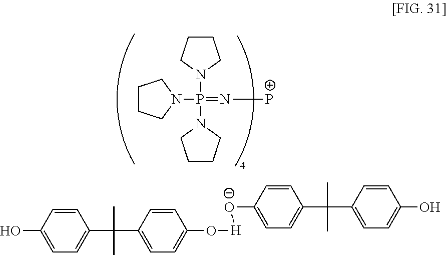

### Example 6: Synthesis of Catalyst F

### Step 1: Synthesis of trichloro[(trichlorophosphoranylidene)amino] phosphorus(V)hexachlorophosphate (Hereinafter may be Abbreviated as [Cl₃P═N═PCl₃] [PCl₆]

6.24 g (30 mmol) of phosphorus pentachloride (Across Organics) was suspended in 15 mL of dichloromethane. Next, tris(trimethylsilyl)amine (Sigma-Aldrich) (2.33 g, 10 mmol) dissolved in 10 mL of dichloromethane was added dropwise with water bath cooling. The mixture was stirred at room temperature for another 2 hours. The precipitated product was isolated by filtration, and dried under vacuum to give 5.08 g of a pale yellow solid. The yield was 95%.

Structural identification by NMR (nuclear magnetic resonance) was as follows.

³¹P {H} NMR (162 MHZ, 298 K, CD₂Cl₂) δ 21.8, −296.6.

### Step 2: Synthesis of 1,1,1,3,3,3-hexakis(cyclohexylamino)-1λ⁵, 3λ⁵-diphosphazenium tetrafluoroborate (Hhereinafter may be Abbreviated as P2(CyNH)-BF₄)

2.39 g of [Cl₃P═N═PCl₃] [PCl₆] (4.5 mmol) was suspended in 15 mL of anhydrous chlorobenzene under an argon atmosphere, then 10.7 g (108 mmol) of cyclohexylamine (Sigma-Aldrich) was added dropwise while cooling in an ice bath. The resulting reaction mixture was then heated to 130° C., and stirred at this temperature for 1 hour. After cooling the reaction mixture to room temperature, sodium tetrafluoroborate (0.49 g, 4.5 mmol) in 20 ml of water was added, and the mixture was stirred for 1 hour. The reaction mixture was filtered, and the chlorobenzene phase in the filtrate was separated and dried over sodium sulfate. The chlorobenzene was distilled off by an evaporator, 30 mL of ether was added to the residue, and the precipitated product was isolated by filtration. Drying in the air gave 2.43 g of a white solid. The yield was 72%.

Structural identification by NMR (nuclear magnetic resonance) was as follows.

¹H NMR (400 MHZ, 298 K, CDCl₃) δ 2.92 (m, 6H, NCH), 2.80 (m, 6H, NH), 1.86 (m, 12H, Cy-H), 1.73 (m, 12H, Cy-H), 1.57 (m, 6H, Cy-H), 1.24 (m, 30H, Cy-H).

¹³C {H} NMR (100 MHZ, 298 K, CD₂Cl₂ δ 53.7, 35.4, 23.7.

³¹P {H} NMR (162 MHZ, 298 K, CDCl₃) δ 5.4.

### (Step 3: Synthesis of 1,1,1,3,3,3-hexakis(cyclohexyl(methyl)amino)-1λ⁵, 3λ⁵-diphosphazenium tetrafluoroborate (Hereinafter may be Abbreviated as P2(CyNMe)-BF₄)

(1.33 g, 1.77 mmol) of P2(CyNH)-BF₄ was dissolved in 10 ml of chlorobenzene. Next, 10 mL of 50% aqueous sodium hydroxide solution and dimethyl sulfate (Merck) (1.61 g, 12.7 mmol) were added successively. The mixture was stirred overnight at room temperature, and 10 ml of water was added to dissolve the precipitated sodium sulfate. The chlorobenzene phase was separated, dried over sodium sulfate, and the chlorobenzene was distilled off using an evaporator. 20 mL of ether was added to the residue, and the precipitated product was isolated by filtration and dried in air to give 1.10 g of a white solid in 74% yield.

Structural identification by NMR (nuclear magnetic resonance) was as follows.

¹H NMR (400 MHZ, 298 K, CDCl₃) δ 3.17 (m, 6H, NCH), 2.49 (m, 18H, N—CH₃), 1.86 (m, 12H, Cy-H), 1.60 (m, 30H, Cy-H), 1.23 (m, 12H, Cy-H), 1.07 (m, 6H, Cy-H).

¹³C {H} NMR (100 MHz, 298 K, CDCl₂) δ 55.7, 33.1, 28.1, 26.1, 25.2.

³¹P {H} NMR (162 MHZ, 298 K, CDCl₃) δ 14.1.

### Step 4: Synthesis of 1,1,1,3,3,3-hexakis(cyclohexyl(methyl)amino)-1λ⁵, 3λ⁵-diphosphazenium 4-(2-(4-hydroxyphenyl)propane-2-yl)phenolate ion BPA Adduct (Hereinafter may be Abbreviated as (P2(CyNMe)-BPA₂)

0.84 g (1.0 mmol) of P2(CyNMe)-BF4 was treated according to Synthesis Example 1 to give Catalyst F represented by the following structural formula (hereinafter may be abbreviated as P2(CyNMe)-BPA₂) in 86% yield.

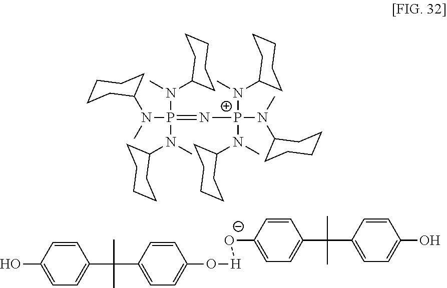

Structural identification by NMR (nuclear magnetic resonance) was as follows.

¹H NMR (400 MHZ, 298 K, d₆-DMSO) δ 6.82, 6.46 (each d, ³J_{H-H}=7.6 Hz, each 8H, BPA-H), 3.13 (m, 6H, NCH), 2.45 (m, 18H, N—CH₃) 1.78 (m, 12H, Cy-H), 1.67-1.51 (m, 30H, Cy-H), 1.47 (s, 12H, BPA-CH₃), 1.20 (m, 12H, Cy-H), 1.04 (m, 6H, Cy-H).

¹³C {H} NMR (100 MHZ, 298 K, d₆-DMSO) δ 157.6, 139.1, 127.0, 115.1, 54.9, 40.6, 30.9, 30.3, 27.5, 25.5, 24.7.

³¹P {H} NMR (162 MHZ, 298 K, d₆-DMSO) δ 13.9.

The result of elemental analysis showed theoretical calculated values of C₇₂H₁₁₅N₇O₄P₂: C71.78, H9.62, N8.14, whereas the measured values were C71.70, H9.67, N8.27.

The result of a thermal stability test of the compound obtained is shown in Table 1.

### Example 15: Synthesis of Catalyst G

### Step 1: Synthesis of tetrakis[(triphenylphosphoranylidene)amino] phosphonium tetrafluoroborate (Hereinafter may be Abbreviated as P5(Ph)-BF₄)

(3.48 g, 12.5 mmol) of Ph₃P═N obtained by the methods described in M. Taillefer, N. Rahier, A. Hameau and J.-N. Volle, Chem. Commun. 2006, 3238-3239; M. G. Davidson, A. E. Goeta, J. A. K. Howard, C. W. Lehmann, G. M. Mcintyre and R. D. Price, J. Organomet. Chem. 1998, 550, 449-452 was dissolved in 20 mL of anhydrous chlorobenzene and cooled in an ice water bath. Phosphorus pentachloride (0.29 g, 1.40 mmol) was added under an argon atmosphere. The reaction mixture was slowly heated to 160° C. in an oil bath, and maintained at this temperature for 20 hours. The resulting suspension was hot-filtered, and the remaining white solid was washed with 10 mL of heated chlorobenzene. All volatile matter in the filtrate was removed with a rotary evaporator. The residue was treated with 10 mL of ether, and the precipitated solid was isolated by filtration. The resulting solid was dissolved in 10 mL of DCM, and treated with 5 mL of NaBF₄ (0.20 g, 1.8 mmol) in water; the DCM layer was separated and dried with Na₂SO₄. After removal of DCM, the remaining solid was treated with 10 mL of ether, filtered and dried in air to give 0.98 g of P5(Ph)-BF₄ as a white product. The yield was 57%.

Structural identification by NMR (nuclear magnetic resonance) was as follows.

¹H NMR (400 MHZ, 298 K, CD₂Cl₂) δ 7.60 (m, 12H), 7.24 (m, 24H), 7.10 (m, 24H).

¹³C {H} NMR (100 MHZ, 298 K, CD₂Cl₂) δ 132.9 (d), 131.6, 131.3 (dd), 128.3 (d).

³¹P {H} NMR (162 MHZ, 298 K, CD₂Cl₂) δ 2.7 (d, ²J_{P-P}=4.8 Hz), −10.1 (quintet, ²J_{P-P}=4.8 Hz).

The result of elemental analysis showed theoretical calculated values of C₇₂H₇₇NO₆P₂: C70.71, H4.95, N4.58, whereas the measured values were C70.12, H4.80, N4.45.

The ESI-MS spectrum showed a theoretical calculated value of m/z: 1135.35, and the measured value was m/z: 1135.35.

### Step 2: Synthesis of tetrakis[(triphenylphosphoranylidene)amino]phosphonium 4-(2-(4-hydroxyphenyl)propane-2-yl) phenolate BPA adduct (Hereinafter may be Abbreviated as P5(Ph)-BPA_{1.67}

To (0.74 g, 0.61 mmol) of P5(Ph)-BF₄ dissolved in 5 mL of methanol, K-BPA₂ (prepared in situ by adding potassium tert-butoxide (68 mg, 0.61 mmol) and BPA (278 mg, 1.22 mmol) in 5 mL of methanol) was added. The mixture was stirred at room temperature for 1 h. 10 mL of DCM was added, and the mixture was filtered. All solvent was distilled off by an evaporator. The remaining solid was refluxed with 10 mL of methanol, and then cooled to room temperature. The precipitated white solid was isolated by filtration and dried in air to give 0.78 g of Catalyst G (P5(Ph)-BPA_{1.67}) in 81% yield. ¹H NMR analysis showed that the product contained 1.67 equivalents of BPA.

Structural identification by NMR (nuclear magnetic resonance) was as follows.

¹H NMR (400 MHZ, 298 K, CD₂Cl₂/CD₃OD=1:4) δ 7.60 (m, 12H), 7.24 (m, 24H), 7.10 (m, 24H), 6.98, 6.62 (each d, ³J_{H-H}=7.6 Hz, each 6.6H, BPA-H), 1.56 (s, 10H, BPA-CH₃).

¹³C {H} NMR (100 MHZ, 298 K, CD₂Cl₂/CD₃OD=1:4) δ 157.0, 140.9, 132.9 (d), 131.6, 131.3 (dd), 128.3 (d), 127.5, 115.3, 41.2, 30.9.

³¹P {H} NMR (162 MHZ, 298 K, CD₂Cl₂) δ 2.7 (d, ²J_{P-P}=4.8 Hz), &#8210; 10.2 (quintet, ²J_{P-P}=4.8 Hz).

The ESI-MS spectrum showed a theoretical calculated value of m/z: 1135.35, and the measured value was m/z: 1135.35.

The result of a thermal stability test of the compound obtained is shown in Table 1.

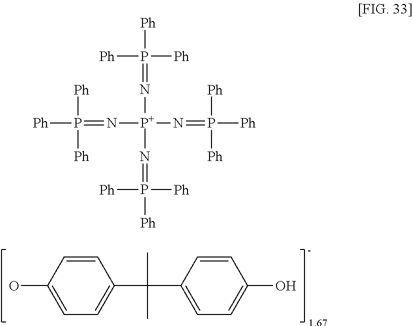

### Comparative Example 1: Synthesis of Catalyst H

0.8 g of 2-Et-1,4-Ad₂-imidazolium bromide was dissolved in 5 mL of THF. Next, the solution containing 2-Et-1,4-Ad₂-imidazolium bromide was added to a solution of 188 mg of potassium tert-butoxide (Sigma-Aldrich) dissolved in 2 mL of THF. The mixture was stirred at room temperature for 14 hours. The filtrate was collected, and the residual solvent was removed by a rotary evaporator to give 580 mg of a yellow solid (2-Et-1,4-Ad₂-imidazole).

Next, 400 mg of 2-Et-1,4-Ad₂-imidazole was dissolved in 3 mL of iodomethane, and stirred at 45° C. for 14 hours. After removing the iodomethane with a rotary evaporator, 10 mL of diethyl ether was added, and the solid was filtered and dried to give 552 mg of bluish yellow crystals (2-Et-1,4-Ad₂-3-Me-imy-I).

Next, 653 mg of 2-Et-1,4-Ad₂-3-Me-imy-I was dissolved in 3 mL of THF and 1 mL of ethanol. Also, 252 mg of AgBF₄ was dissolved in 3 mL of THF and 1 mL of ethanol. The solution containing AgBF4 was added dropwise to the solution containing 2-Et-1,4-Ad₂-3-Me-imy-I. Next, 294 mg of BPA and 145 mg of potassium tertiary butoxide (Sigma-Aldrich) were dissolved in 3 mL of THF and 1 mL of ethanol. This solution was mixed with the solution containing 2-Et-1,4-Ad₂-3-Me-imy-I, stirred at room temperature for 4 hours, and the filtrate was collected. The residual solvent in the filtrate was removed with a rotary evaporator, and the solids were extracted by DCM. The DCM in the solution was removed with a rotary evaporator to give 670 mg of Catalyst H represented by the following structural formula (may be abbreviated as 2-Et-1,4-Ad₂-3-Me-imy-BPA, purity 85%).

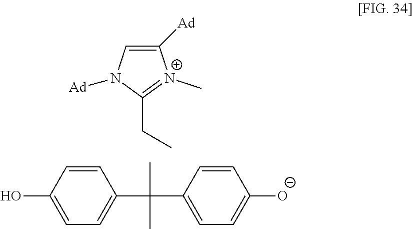

Structural identification by NMR (nuclear magnetic resonance) was as follows.

¹H NMR (400 MHZ, 298 K): δ 7.20 (s, 1H, 5-H), 6.70, 6.32 (each d, ³J_{H-H}=8.6 Hz, each 4H, BPA-H), 3.86 (s, 3H, N—CH₃), 3.22 (q, ³J_{H-H}=7.4 Hz, 2H, CH₂H₃), 2.18 (9H, Ad-H), 2.04 (3H, Ad-H), 1.96 (6H, Ad-H), 1.76-1.66 (12H, Ad-H), 1.44 (s, 6H, BPA-H), 1.20 (t, ³J_{H-H}=7.4 Hz, 3H, CH₂CH₃)

### Comparative Example 2: Synthesis of Catalyst I

13.2 g of 3-hydroxybutan-2-one was mixed with 13.5 g of mesitylamine, 150 mL of toluene and 0.05 mL of hydrogen chloride, and refluxed under a nitrogen atmosphere for 3 hours. After cooling the resulting yellow solution to room temperature, the solvent was removed using a rotary evaporator to give 15.4 g of 3-(mesitylamino)butan-2-one.

Next, 4.1 g of 3-(mesitylamino)butan-2-one, 5.6 mL of triethylamine, 7.9 g of acetyl chloride, and 30 mL of DCM were mixed at 0° C. and stirred for 14 hours at room temperature. The precipitated ammonium salt was filtered off. DCM was distilled off from the solution, and the resulting solution was separated on a silica gel column. The product was eluted with a mixture of hexane and ethyl acetate (4:1 w/w) to give 3.2 g of a bluish yellow liquid. Next, 2.5 g of the resulting liquid was mixed with 10.3 g of acetic anhydride, and 0.84 mL of 37% aqueous hydrogen chloride solution was added. The mixture was stirred at room temperature for 14 hours, and 50 mL of diethyl ether was added. The organic solution layer was collected and washed twice with 2 mL of diethyl ether. The resulting oily substance was mixed with 20 ml of toluene and 2.0 g of mesitylamine, and stirred at room temperature for 3 hours. The mixture was washed with 50 mL of anhydrous diethyl ether, mixed with 6 mL of acetic anhydride, 20 mL of toluene, and 1.3 mL of 37% aqueous hydrogen chloride solution, and stirred at 110° C. for 14 hours. The solvent was removed with a rotary evaporator to give 1.4 g of white 2,4,5-Me₃-1,3-Mes₂-imy-Cl.

Next, 500 mg of 2,4,5-Me₃-1,3-Mes₂-imy-Cl was dissolved in 2 mL of THF and 0.5 mL of ethanol. Then, 228 mg of BPA and 112 mg of potassium tert-butoxide were dissolved in 2 mL of THF and 0.5 mL of ethanol. The solution containing 2,4,5-Me₃-1,3-Mes₂-imy-Cl and the solution containing BPA were stirred at 60° C. for 1 hour, and the filtrate was collected. After removing the solvent in the filtrate with a rotary evaporator, it was mixed with 5 mL of DCM; the DCM was removed with a rotary evaporator, and 495 mg of Catalyst I represented by the following structural formula (hereinafter may be abbreviated as Mes₂-2,4,5-Me₃-imy-BPA, purity 86%) was obtained.

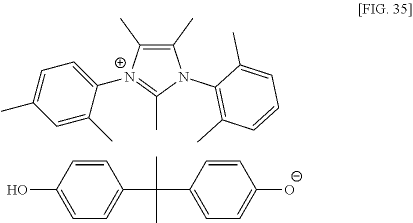 [SMILES: Cc1ccc(-[n+]2c(C)c(C)n(-c3c(C)cccc3C)c2C)c(C)c1 ; CC(C)(c1ccc([O-])cc1)c1ccc(O)cc1]

Structural identification by NMR (nuclear magnetic resonance) was as follows.

¹H NMR (400 MHZ, 298 K): δ 7.23 (s, 4H, Ar—H), 6.68 (d, ³J_{H-H}=8.6 Hz, 4H, Ar—H), 6.30 (d, ³J_{H-H}=8.6 Hz, 4H, Ar—H), 2.36 (s, 6H, C 4,5-CH₃), 2.10 (s, 3H, C2-CH₃), 2.02 (s, 12H, Ar—CH₃), 2.01 (s, 6H, Ar—CH₃), 1.43 (s, 6H, BPA-CH₃)

### Comparative Example 3: Synthesis of Catalyst J

15.7 mg of 1,3-Bis(1-adamantyl)imidazol-2-ylidene (Strem Chemicals), 7.6 mL of THF and 10.6 mg of BPA were mixed, 1.5 mL of methanol was added, and a solution containing Catalyst J represented by the following structural formula (hereinafter may be abbreviated as Ad₂-imy-BPA) was obtained.

The result of a thermal stability test of the compound obtained is shown in Table 1.

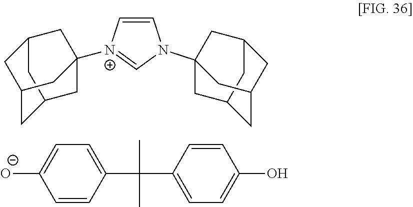 [SMILES: c1c[n+](C23CC4CC(CC(C4)C2)C3)cn1C12CC3CC(CC(C3)C1)C2 ; CC(C)(c1ccc([O-])cc1)c1ccc(O)cc1]

### Comparative Example 4: Synthesis of Catalyst L

116 mg of sodium phenoxide, 1 mL of THF and 189 mg of iPr2-imy-Cl (Strem Chemicals, 97%) were mixed and stirred at room temperature for 14 hours. The solids were removed by filtration, and the THF in the solution was distilled off using a rotary evaporator to give 231 mg of Catalyst L represented by the following structural formula (hereinafter may be abbreviated as iPr₂-imy-OPh).

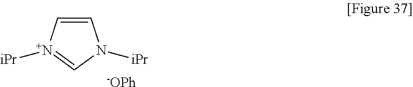 [SMILES: CC(C)n1cc[n+](C(C)C)c1 ; "-OPh"]

### Catalyst M

As Catalyst M, 2-tert-butylimino-2-diethylamino-1,3 Dimethylperhydro-1,3,2-diazaphospholine (hereinafter may be abbreviated as BEMP) (Sigma-Aldrich), was used.

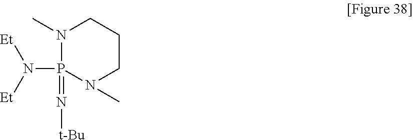 [SMILES: CCN(CC)P1(=NC(C)(C)C)N(C)CCCN1C]

### Catalyst K

As Catalyst K, tetramethylammonium hydroxide represented by the following structural formula (hereinafter may be abbreviated as TMAH) (97%, Sigma-Aldrich), was used.

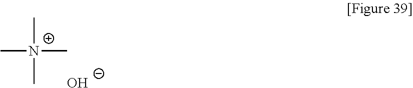

### Production of Thermoplastic Resin

### Example 7

A mixture was prepared by introducing 116.71 g (approx. 0.51 mol) of BPA and 117.95 g (approx. 0.55 mol) of DPC to a glass reactor with a capacity of 150 mL equipped with a reactor stirrer, reactor heating device, and reactor pressure adjustment device, and adding Catalyst A as the transesterification catalyst at a concentration of 3 μmol per 1 mol of BPA.

Next, the inside of the glass reactor was depressurized to approx. 100 Pa (0.75 Torr), followed by three cycles of restoring the pressure to atmospheric pressure with nitrogen to replace the inside of the reactor with nitrogen. After nitrogen replacement, the temperature outside the reactor was set to 220° C., and the internal temperature of the reactor was gradually increased to dissolve the mixture. The stirrer was then rotated at 100 rpm. Then, the pressure inside the reactor was reduced from 101.3 kPa (760 Torr) to 13.3 kPa (100 Torr) in absolute pressure over 40 minutes, while distilling off phenol which is a by-product of the oligomerization reaction between BPA and DPC that takes place inside the reactor.

The pressure in the reactor was then maintained at 13.3 kPa, and a transesterification reaction was carried out for 80 minutes while further distilling off phenol. The temperature outside the reactor was then increased to 290° C., and the pressure inside the reactor was reduced from 13.3 kPa (100 Torr) to 399 Pa (3 Torr) in absolute pressure over 40 minutes to remove phenol that was distilled off, outside the system. The absolute pressure in the reactor was further reduced to 30 Pa (approx. 0.2 Torr) to carry out the polycondensation reaction. The polycondensation reaction was terminated when the stirrer in the reactor reached a predetermined stirring power.

The reaction time from the start of the reaction to the end of the reaction was measured, and is recorded in Table 2 as the polymerization time (units: minutes).

Then, the pressure in the reactor was increased to 0.2 MPa in gauge pressure after restoring the absolute pressure to 101.3 kPa with nitrogen, and the polycarbonate resin was extracted from the bottom of the reactor tank in the form of strands so as to obtain stranded polycarbonate resin, which was then pelletized using a rotary cutter.

Evaluation results for the polycarbonate resin obtained are shown in Table 2.

### Example 8

A polycarbonate resin was obtained by polymerization in the same manner as in Example 7, except that 116.71 g (approx. 0.51 mol) of BPA and 117.73 g (approx. 0.55 mol) of DPC were introduced, and Catalyst A was added at 2 μmol per 1 mol of BPA. The polymerization time and evaluation results for the polycarbonate resin obtained are shown in Table 2.

### Example 9

A polycarbonate resin was obtained by polymerization in the same manner as in Example 7, except that 116.71 g (approx. 0.51 mol) of BPA and 116.85 g (approx. 0.55 mol) of DPC were introduced, and Catalyst A was added at 1 μmol per 1 mol of BPA. The polymerization time and evaluation results for the polycarbonate resin obtained are shown in Table 2.

### Example 10

A polycarbonate resin was obtained by polymerization in the same manner as in Example 7, except that 116.71 g (approx. 0.51 mol) of BPA and 118.28 g (approx. 0.55 mol) of DPC were introduced, and the transesterification Catalyst B was added at 2.5 μmol per 1 mol of BPA. The polymerization time and evaluation results for the polycarbonate resin obtained are shown in Table 2.

### Example 11

A polycarbonate resin was obtained by polymerization in the same manner as in Example 7, except that 116.71 g (approx. 0.51 mol) of BPA and 118.28 g (approx. 0.55 mol) of DPC were introduced, and Catalyst C was added as the transesterification catalyst instead of Catalyst A at 2.5 μmol per 1 mol of BPA. The polymerization time and evaluation results for the polycarbonate resin obtained are shown in Table 2.

### Example 12

A polycarbonate resin was obtained by polymerization in the same manner as in Example 7, except that 3 μmol of Catalyst D was used per 1 mol of BPA instead of Catalyst A as the transesterification catalyst in Example 7. The polymerization time and evaluation results for the polycarbonate resin obtained are shown in Table 2.

### Example 13

A polycarbonate resin was obtained by polymerization in the same manner as in Example 7, except that 3 μmol of Catalyst E was used per 1 mol of BPA instead of Catalyst A as the transesterification catalyst in Example 7. The polymerization time and evaluation results for the polycarbonate resin obtained are shown in Table 2.

### Example 14

A polycarbonate resin was obtained by polymerization in the same manner as in Example 7, except that 3 μmol of Catalyst F was used per 1 mol of BPA instead of Catalyst A as the transesterification catalyst in Example 7. The polymerization time and evaluation results for the polycarbonate resin obtained are shown in Table 2.

### Example 16

A polycarbonate resin was obtained by polymerization in the same manner as in Example 7, except that 3 μmol of Catalyst G was used per 1 mol of BPA instead of Catalyst A as the transesterification catalyst in Example 7. The polymerization time and evaluation results for the polycarbonate resin obtained are shown in Table 2.

### Comparative Example 5

A polycarbonate resin was obtained by polymerization in the same manner as in Example 7, except that 116.71 g (approx. 0.51 mol) of BPA and 117.73 g (approx. 0.55 mol) of DPC were introduced, and Catalyst H was added as the transesterification catalyst instead of Catalyst A at 7.7 μmol per 1 mol of BPA in Example 7. The polymerization time and evaluation results for the polycarbonate resin obtained are shown in Table 2.

### Comparative Example 6

A polycarbonate resin was obtained by polymerization in the same manner as in Example 7, except that 116.71 g (approx. 0.51 mol) of BPA and 117.73 g (approx. 0.55 mol) of DPC were introduced, and Catalyst I was added as the transesterification catalyst instead of Catalyst A at 7 μmol per 1 mol of BPA in Example 7. The polymerization time and evaluation results for the polycarbonate resin obtained are shown in Table 2.

### Comparative Example 7

A polycarbonate resin was obtained by polymerization in the same manner as in Example 7, except that 116.71 g (approx. 0.51 mol) of BPA and 118.83 g (approx. 0.55 mol) of DPC were introduced, and Catalyst I was added instead of Catalyst A as the transesterification catalyst at 5 μmol per 1 mol of BPA in Example 7. The polymerization time and evaluation results for the polycarbonate resin obtained are shown in Table 2.

### Comparative Example 8

A polycarbonate resin was obtained by polymerization in the same manner as in Example 7, except that 116.71 g (approx. 0.51 mol) of BPA and 117.84 g (approx. 0.55 mol) of DPC were introduced, and Catalyst J was added instead of Catalyst A as the transesterification catalyst at 7 μmol per 1 mol of BPA in Example 7. The polymerization time and evaluation results for the polycarbonate resin obtained are shown in Table 2.

### Comparative Example 9

A polycarbonate resin was obtained by polymerization in the same manner as in Example 7, except that 116.71 g (approx. 0.51 mol) of BPA and 117.73 g (approx. 0.55 mol) of DPC were introduced, and Catalyst J was added as the transesterification catalyst instead of Catalyst A at 20 μmol per 1 mol of BPA in Example 7. The polymerization time and evaluation results for the polycarbonate resin obtained are shown in Table 2.

### Comparative Example 10

A polycarbonate resin was obtained by polymerization in the same manner as in Example 7, except that 116.71 g (approx. 0.51 mol) of BPA and 118.83 g (approx. 0.55 mol) of DPC were introduced, and Catalyst K was added as the transesterification catalyst instead of Catalyst A at 5 μmol per 1 mol of BPA in Example 7. The polymerization time and evaluation results for the polycarbonate resin obtained are shown in Table 2.

### Comparative

### Example 11

A polycarbonate resin was obtained by polymerization in the same manner as in Example 7, except that 116.71 g (approx. 0.51 mol) of BPA and 118.83 g (approx. 0.55 mol) of DPC were introduced, and Catalyst L was added instead of Catalyst A as the transesterification catalyst at 5 μmol per 1 mol of BPA in Example 7. The polymerization time and evaluation results for the polycarbonate resin obtained are shown in Table 2.

### Comparative Example 12

A polycarbonate resin was obtained by polymerization in the same manner as in Example 7, except that 116.71 g (approx. 0.51 mol) of BPA and 115.43 g (approx. 0.54 mol) of DPC were introduced, and Catalyst M was added as the transesterification catalyst instead of Catalyst A at 10 μmol per 1 mol of BPA in Example 7. The polymerization time and evaluation results for the polycarbonate resin obtained are shown in Table 2.

TABLE 1

| | | | | Decomposition |
|---|---|---|---|---|
| | | Symbol | Abbreviation | rate |
| Example | 1 | A | P5-BPA₂ | 0 |
| Example | 2 | B | P5-OPh | 8 |
| Example | 4 | D | P2-BPA₂ | 1 |
| Example | 5 | E | P5(pyr)-BPA₂ | 14 |
| Example | 6 | F | P2(CyNMe)-BPA₂ | 2 |
| Example | 15 | G | P5(Ph)-BPA_{1.67} | 0 |
| Comparative | 3 | J | Ad2-imy-BPA | 46 |
| Example | | | | |
| Comparative | 12 | M | BEMP | 85 |
| Example | | | | |

TABLE 2

| | | | | | | | Evaluation of polycarbonate resin | | |
|---|---|---|---|---|---|---|---|---|---|
| | | | | | Reaction conditions | | | Terminal | |
| | | | | | | Polymer- | Molecular | hydroxyl | Content of |
| | | Catalyst | | | Catalyst | ization | weight | group | specified |
| | | | | Obtaining | concentration | time | (Mv) | concentration | compounds |
| | | Symbol | Abbreviation | method | (※) | (min) | — | ppm | ppm |
| Example | 7 | A | P5-BPA₂ | Synthesized | 3 | 230 | 21528 | 466 | 504 |
| | | | | in Ex. 1 | | | | | |
| Example | 8 | A | P5-BPA₂ | Synthesized | 2 | 227 | 22371 | 568 | 482 |
| | | | | in Ex. 1 | | | | | |
| Example | 9 | A | P5-BPA₂ | Synthesized | 1 | 235 | 21400 | 769 | 431 |
| | | | | in Ex. 1 | | | | | |
| Example | 10 | B | P5-OPh | Synthesized | 2.5 | 238 | 21996 | 435 | 422 |
| | | | | in Ex. 2 | | | | | |
| Example | 11 | C | P5-BPh₄ | Synthesized | 2.5 | 243 | 22159 | 444 | 441 |
| | | | | in Ex. 3 | | | | | |
| Example | 12 | D | P5-BPA₂ | Synthesized | 3 | 220 | 22108 | 503 | 540 |
| | | | | in Ex. 4 | | | | | |
| Example | 13 | E | P5(pyr)-BPA₂ | Synthesized | 3 | 235 | 21363 | 489 | 496 |
| | | | | in Ex. 5 | | | | | |
| Example | 14 | F | P2(CyNMe)-BPA₂ | Synthesized | 2 | 232 | 20376 | 614 | 448 |
| | | | | in Ex. 6 | | | | | |
| Example | 16 | G | [symbol] | Synthesized | 3 | 230 | 20516 | 471 | 381 |
| | | | | in Ex. 15 | | | | | |
| Comparative | 5 | H | [symbol] | Synthesized in | 7.7 | 255 | 21554 | 644 | 661 |
| Example | | | | Comparative | | | | | |
| | | | | Ex. 1 | | | | | |
| Comparative | 6 | I | [symbol] | Synthesized in | 7 | 250 | 22062 | 414 | 729 |
| Example | | | | Comparative | | | | | |
| | | | | Ex. 2 | | | | | |
| Comparative | 7 | I | [symbol] | Synthesized in | 5 | 346 | 20679 | 264 | 556 |
| Example | | | | Comparative | | | | | |
| | | | | Ex. 2 | | | | | |
| Comparative | 8 | J | [symbol] | Synthesized in | 7 | 265 | 21052 | 488 | 466 |
| Example | | | | Comparative | | | | | |
| | | | | Ex. 3 | | | | | |
| Comparative | 9 | J | [symbol] | Synthesized in | 20 | 265 | 20573 | 434 | 576 |
| Example | | | | Comparative | | | | | |
| | | | | Ex. 3 | | | | | |
| Comparative | 10 | K | [symbol] | By using | 5 | 320 | 17320 | 196 | 1704 |
| Example | | | | reagents | | | | | |
| Comparative | 11 | L | [symbol] | Synthesized in | 5 | 310 | 18019 | 415 | 701 |
| Example | | | | Comparative | | | | | |
| | | | | Ex. 4 | | | | | |
| Comparative | 12 | | | By using | | | | | |
| Example | | | | reagents | | | | | |

* Catalyst amount per 1 mol of BPA (μmol/mol BPA) [symbol]
indicates data missing or illegible when filed

### Discussion

Table 1 shows that the catalytic compounds of the present invention obtained in Examples 1, 2, 4˜6, and 15 have low decomposition rates and excellent thermal stability.

In contrast, catalysts J and M in Comparative Examples 3 and 12 have high decomposition rates and poor thermal stability.

As shown in Table 2, Examples 7˜14 and 16 using the transesterification catalyst of the present invention have excellent reactivity because the polymerization time is as short as 245 minutes or less even with a small amount of catalyst (3 μmol or less), and the specified by-product content is also excellent at 550 ppm or less. In contrast, in Comparative Example 5, although 7.7 μmol of catalyst was used, the reaction time was the same or longer than in Examples, and the specified by-product content was higher than in Examples. In Comparative Example 6, 7 μmol of catalyst was used, but the reaction time was the same or longer than in Examples, and the specified by-product content was also higher than in Examples. In Comparative Example 7, 5 μmol of the same catalyst as in Comparative Example 6 was used, which is less than in Comparative Example 6, and the specified by-product content tended to improve compared to Comparative Example 6, but the polymerization time was longer.

In Comparative Example 8, specified by-products were low and at the same level as in Examples, but the polymerization time was longer.

In Comparative Example 9, 20 μmol of the same catalyst as in Comparative Example 8 was used, which is more than in Comparative Example 8, but there was no improvement in reactivity, and the specified by-product content also tended to increase.

In Comparative Examples 10, 11, and 12, more catalyst was used than in Examples, but the reaction time was longer and the specified by-product content was also higher.

Although the present invention has been described in detail by reference to specific aspects, it will be understood by those skilled in the art that various modifications are possible without departing from the spirit and scope of the present invention.

This application is based on Japanese Patent Application 2021-048264, filed on Mar. 23, 2021, and is supported in its entirety by reference thereto.

1. A method for producing at least one thermoplastic resin selected from a group consisting of a polycarbonate, polyester and polyester carbonate, comprising a process of melt polycondensation of a dihydroxy compound with a diaryl carbonate and/or a dicarboxylic acid ester in a presence of a transesterification catalyst selected from a compound represented by formula (1) below and/or a compound represented by formula (2) below. 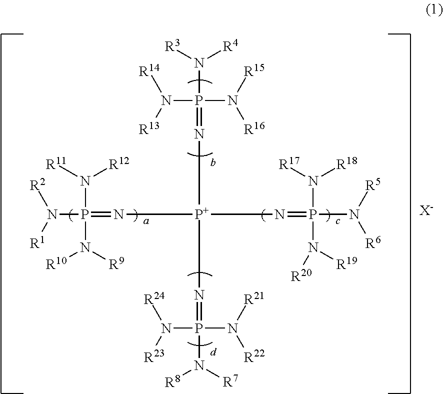
in formula (1), R¹˜R²⁴ are each independently a hydrogen atom, an alkyl group having 1˜10 carbon atoms, or a cycloalkyl group, wherein some carbon atoms of the alkyl group and the cycloalkyl group may be replaced by heteroatoms, and among R¹˜R²⁴, alkyl groups substituted on a same N atom may be joined together to form a ring; R² and R³, R⁴ and R⁵, R⁶ and R⁷, R⁸ and R¹ may respectively be joined together to form a ring; R⁹ or R¹⁰, R¹ or R², and R¹¹ or R¹² may respectively be joined together to form a ring; R¹³ or R¹, R³ or R⁴, and R¹⁵ or R¹⁶ may respectively be joined together to form a ring; R¹⁷ or R¹⁸, R⁵ or R⁶ and R¹⁹ or R²⁰ may respectively be joined together to form a ring; R²¹ or R²², R⁷ or R⁸, and R²³ or R²⁴ may respectively be joined together to form a ring; R¹ or R², R³ or R⁴, and R⁵ or R⁶ may respectively be joined together to form a ring; R³ or R⁴, R⁵ or R⁶, and R⁸ or R⁷ may respectively be joined together to form a ring: R⁵ or R⁶, R⁸ or R⁷, and R¹ or R² may respectively be joined together to form a ring; and R⁷ or R⁸, R¹ or R², and R³ or R⁴ may respectively be joined together to form a ring; a˜d are independently 0 or 1; X⁻ is a monovalent anion; 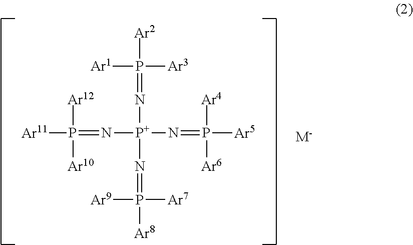
in formula (2), Ar¹˜Ar¹² each independently represent a substituted or unsubstituted aryl group; M⁻ represents a monovalent anion.

2. The method for producing at least one thermoplastic resin selected from a group consisting of a polycarbonate, a polyester, and a polyester carbonate according to claim 1, wherein said dihydroxy compound is bisphenol A.

3. The method for producing at least one thermoplastic resin selected from a group consisting of a polycarbonate, a polyester, and a polyester carbonate according to claim 1, wherein said diaryl carbonate is diphenyl carbonate.

4. The method for producing at least one thermoplastic resin selected from a group consisting of a polycarbonate, a polyester, and a polyester carbonate according to claim 1, wherein said dicarboxylic acid ester is diphenyl terephthalate and/or diphenyl isophthalate.

5. The method for producing at least one thermoplastic resin selected from a group consisting of a polycarbonate, a polyester, and a polyester carbonate according to claim 1, comprising the process of melt polycondensation of an aromatic dihydroxy compound and a diaryl carbonate in the presence of said transesterification catalyst.

6. The method for producing at least one thermoplastic resin selected from a group consisting of a polycarbonate, a polyester, and a polyester carbonate according to claim 1, wherein said transesterification catalyst is a compound represented by said formula (1).

7. The method for producing at least one thermoplastic resin selected from a group consisting of a polycarbonate, a polyester, and a polyester carbonate according to claim 6, wherein said formula (1) is represented by the following formula (1b): 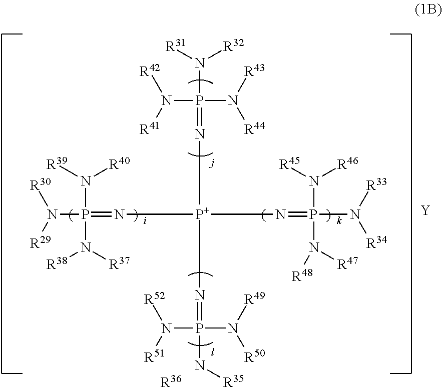
in formula (1B), R²⁹˜R⁵² are each independently a hydrogen atom or an alkyl group having 1˜10 carbon atoms; among R²⁹˜R⁵², alkyl groups substituted on a same N atom may be joined together to form a ring; R³⁰ and R³¹, R³² and R³³, R³⁴ and R³⁵, R³⁶ and R²⁹ may respectively be joined together to form a ring; i˜1 are independently 0 or 1, respectively; Y⁻ is a monovalent anion.

8. The method for producing at least one thermoplastic resin selected from a group consisting of a polycarbonate, a polyester, and a polyester carbonate according to claim 6, wherein in said formula (1),
X⁻ is at least one kind selected from a chloride ion, a bromide ion, a tetraphenylborate ion, a phenolate ion, a BPA monoanion represented by formula (3a) below, and a BPA monoanion BPA adduct represented by formula (3b) below.

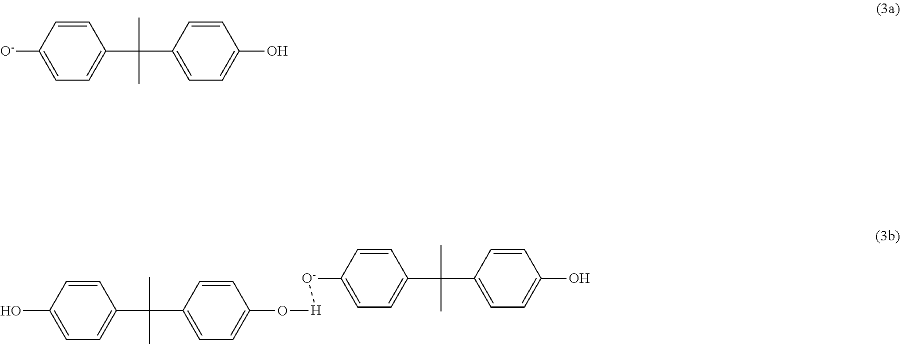

9. The method for producing at least one thermoplastic resin selected from a group consisting of a polycarbonate, a polyester, and a polyester carbonate according to claim 8, wherein in said (1), X⁻ is at least one kind selected from a phenolate ion, a BPA monoanion represented by said formula (3a), and a BPA monoanion BPA adduct represented by said formula (3b).

10. The method for producing at least one thermoplastic resin selected from a group consisting of a polycarbonate, a polyester, and a polyester carbonate according to claim 6, wherein said formula (1) is represented by any of following formulas (1a)˜(1e): 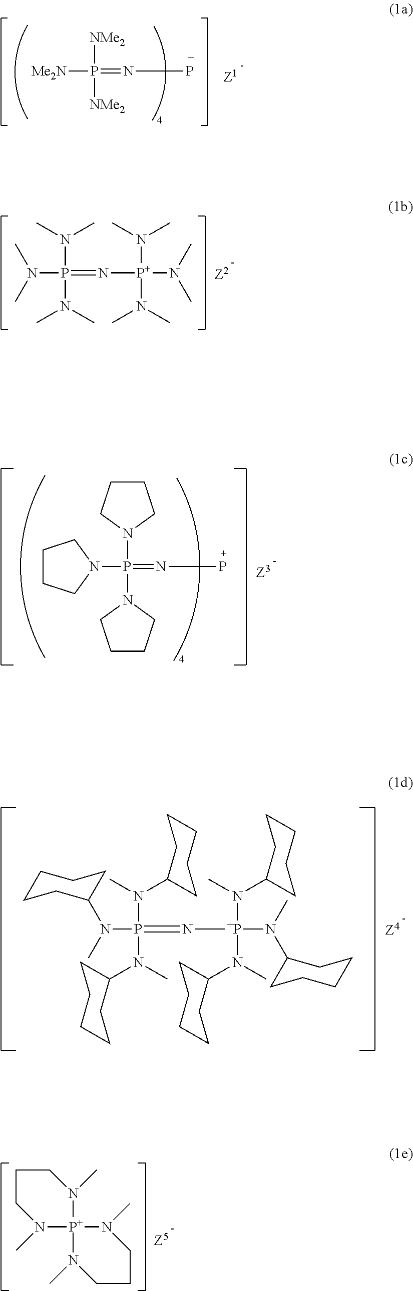
in formulas (1a)˜(1e), Z¹⁻˜Z³⁻ each independently represent a monovalent anion; Me represents a methyl group.

11. The method for producing at least one thermoplastic resin selected from a group consisting of a polycarbonate, a polyester, and a polyester carbonate according to claim 1, wherein said transesterification catalyst is a compound represented by said formula (2).

12. The method for producing at least one thermoplastic resin selected from a group consisting of a polycarbonate, a polyester, and a polyester carbonate according to claim 11, wherein in said formula (2), Ar¹⁻˜Ar¹²⁻ are phenyl groups.

13. The method for producing at least one thermoplastic resin selected from a group consisting of a polycarbonate, a polyester, and a polyester carbonate according to claim 11, wherein, in said formula (2), M⁻ is at least one kind selected from a chloride ion, a bromide ion, a tetraphenylborate ion, a phenolate ion, a BPA monoanion represented by formula (3a) below, and a BPA monoanion BPA adduct represented by formulas (3b), (3c) below.

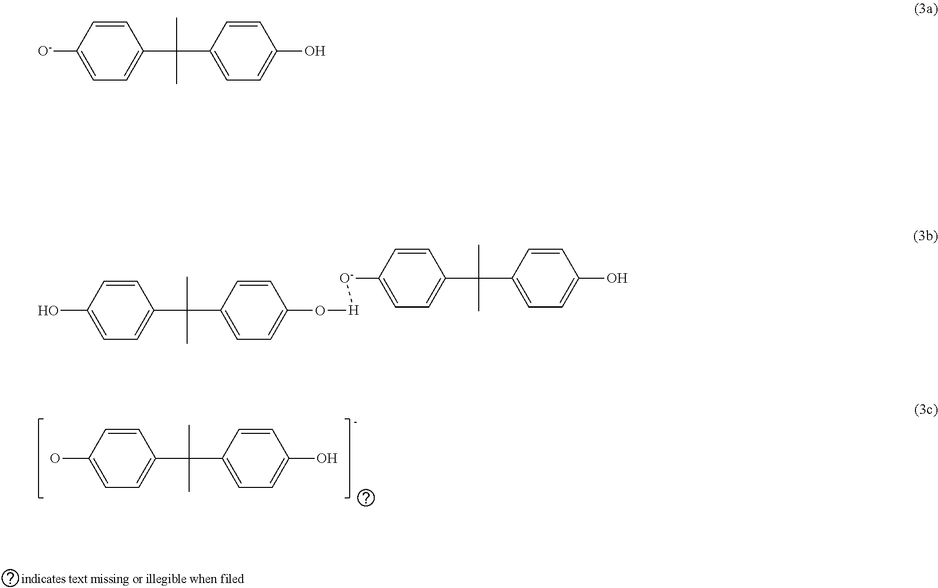

14. The method for producing at least one thermoplastic resin selected from a group consisting of a polycarbonate, a polyester, and a polyester carbonate according to claim 13, wherein, in said formula (2), M⁻ is at least one kind selected from a phenolate ion, a BPA monoanion represented by said formula (3a), and a BPA monoanion BPA adduct represented by said formulas (3b), (3c).

15. The method for producing at least one thermoplastic resin selected from a group consisting of a polycarbonate, a polyester, and a polyester carbonate according to claim 1, wherein one or more of the following apply:
(a) said melt polycondensation is performed in the presence of 0.01˜1000 μmol of said transesterification catalyst per 1 mol of said dihydroxy compound;
(b) a temperature during said melt polycondensation reaction is 200˜350° C.; and
(c) a viscosity average molecular weight (Mv) of said at least one thermoplastic resin selected from a group consisting of a polycarbonate. a polyester. and a polyester carbonate produced is from 5,000 to 40,000.

16. (canceled)

17. (canceled)

18. A transesterification catalyst for producing at least one thermoplastic resin selected from a group consisting of a polycarbonate, a polyester, and a polyester carbonate by melt polycondensation of a dihydroxy compound with a diaryl carbonate and/or a dicarboxylic acid ester, said catalyst being selected from any one of a group of compounds represented by formula (1) below and formula (2) below: 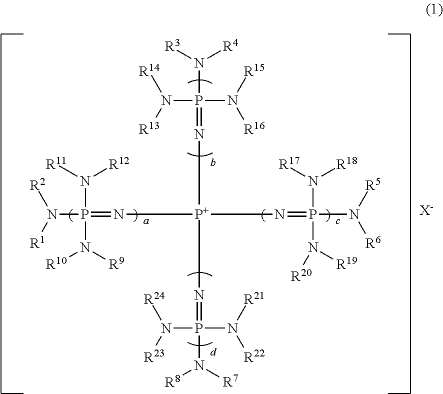
in formula (1), R¹˜R²⁴ are each independently a hydrogen atom, an alkyl group having 1˜10 carbon atoms, or a cycloalkyl group, wherein some carbon atoms of the alkyl group or the cycloalkyl group may be replaced by heteroatoms, and among R¹˜R²⁴, alkyl groups substituted on a same N atom may be joined together to form a ring; R² and R³, R⁴ and R⁵, R⁶ and R⁷, R⁸ and R¹ may respectively be joined together to form a ring; R⁹ or R¹⁰, R¹ or R², and R¹¹ or R¹² may respectively be joined together to form a ring; R¹³ or R¹⁴, R³ or R⁴, and R¹⁵ or R¹⁶ may respectively be joined together to form a ring; R¹⁷ or R¹⁸, R⁵ or R⁶ and R¹⁹ or R²⁰ may respectively be joined together to form a ring; R²¹ or R²², R⁷ or R⁸, and R²³ or R²⁴ may respectively be joined together to form a ring; R¹ or R², R³ or R⁴, and R⁵ or R⁶ may respectively be joined together to form a ring; R³ or R⁴, R⁵ or R⁶, and R⁸ or R⁷ may respectively be joined together to form a ring; R³ or R⁶, R⁸ or R⁷, and R¹ or R² may respectively be joined together to form a ring; and R⁷ or R⁸, R¹ or R², and R³ or R⁴ may respectively be joined together to form a ring; a˜d are independently 0 or 1; X⁻ is a monovalent anion. 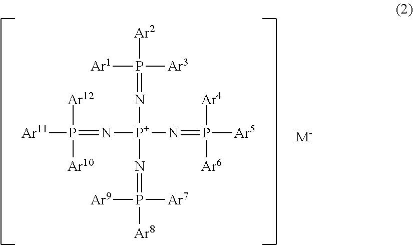
in formula (2), Ar¹˜Ar¹² each independently represent a substituted or unsubstituted aryl group; M⁻ represents a monovalent anion.

19. A compound represented by any of following formulas (1a′)˜(1e′): 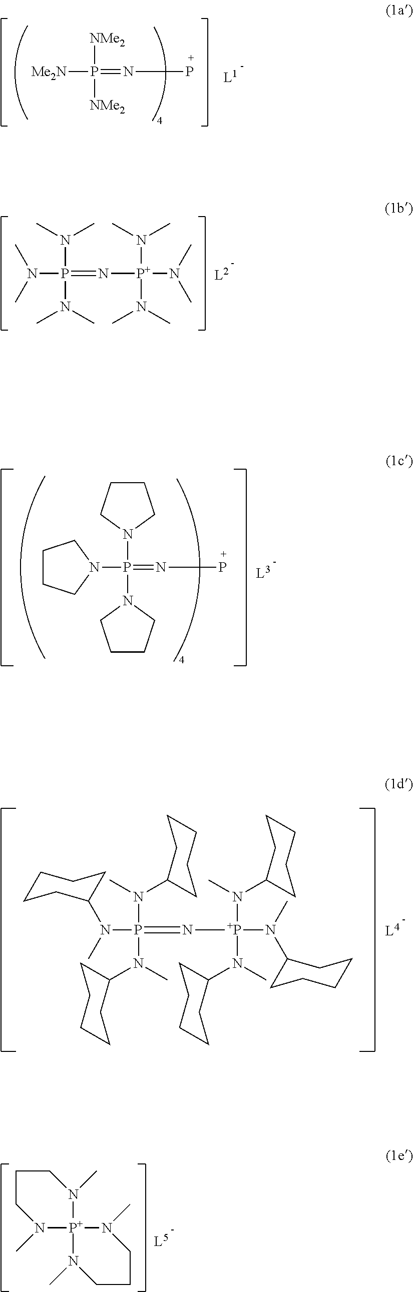
in formulas (1a′) and (1b′), L¹⁻ and L²⁻ are at least one kind selected from a phenolate ion, a BPA monoanion represented by formula (3a) below, and a BPA monoanion BPA adduct represented by formula (3b) below; in said formulas (1c′)˜(1e′), L³⁻˜L⁵⁻ represent a monovalent anion; Me represents a methyl group;

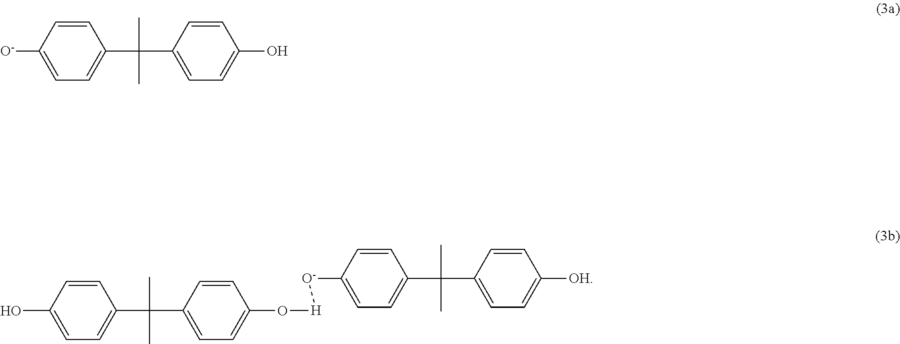

20. A compound represented by the following formula (2): 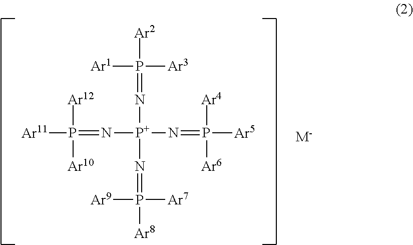
in formula (2), Ar¹˜Ar¹² each independently represent a substituted or unsubstituted aryl group; M⁻ represents a monovalent anion.

21. The polycarbonate produced by the method for producing a thermoplastic resin according to claim 1,
wherein a viscosity average molecular weight of said polycarbonate is 14,000 or more and 30,000 or less, and
a total amount of compounds represented by following formulas (A)˜(E) measured in a hydrolysate of the polycarbonate is 300 wt. ppm or more and 550 wt. ppm or less with respect to the polycarbonate resin: 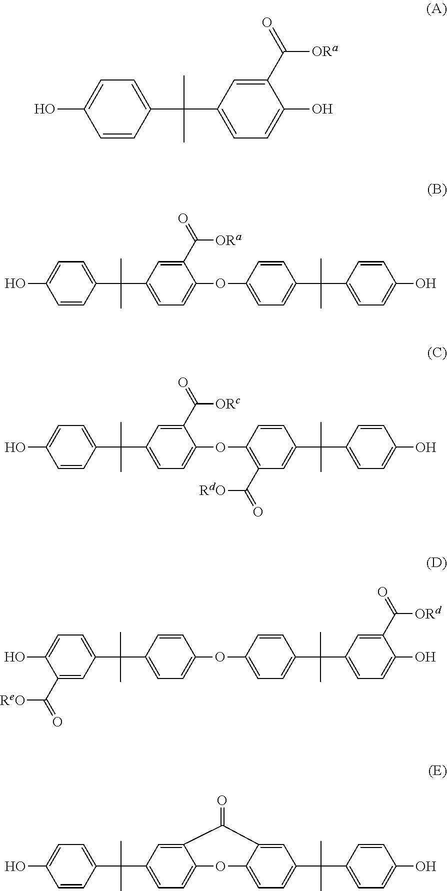
in formulas (A)˜(D), R^{a}˜R^{f} each independently represent a hydrogen atom or a methyl group;
in benzene rings in formulas (A)˜(E), one or more hydrogen atoms bonded to benzene rings may be substituted by a substituent.

22. The polycarbonate of claim 21, wherein a terminal hydroxyl group concentration of said polycarbonate is 400 wt. ppm or more and 1000 wt. ppm or less.
